(19) United States
(12) Patent Application Publication
(10) Pub. No.: US 2017/0116150 A1
(43) Pub. Date: Apr. 27, 2017

(54) N-PHASE FAST BUS TURNAROUND

(71) Applicant: QUALCOMM Incorporated, San Diego, CA (US)

(72) Inventor: George Alan Wiley, San Diego, CA (US)

(21) Appl. No.: 15/299,358

(22) Filed: Oct. 20, 2016

Related U.S. Application Data
(60) Provisional application No. 62/245,587, filed on Oct. 23, 2015.
(60) Provisional application No. 62/333,069, filed on May 6, 2016.

(51) Int. Cl. G06F 13/42; G06F 5/06; G06F 1/32

(52) U.S. Cl. CPC G06F 13/4282; G06F 1/3287; G06F 5/065; G06F 2205/067

(57) ABSTRACT

System, methods and apparatus are described that support multimode operation of a data communication interface. A method includes receiving a first code word transmitted while a physical interface of the device is configured to operate in a low-power mode of operation, reconfiguring the physical interface in response to the first code word such that it operates in a high-speed mode, transmitting data while the physical interface operates in the high-speed mode of operation, receiving a second code word transmitted while the physical interface operated in the high-speed mode of operation, and reconfiguring the physical interface in response to the second code word, such that it operates in the low-power mode of operation. The first code word, the second code word, and the data may be transmitted in signals bound by a common voltage range. In one example, the voltage range is less than 500 millivolts.

### CROSS-REFERENCE TO RELATED APPLICATIONS

This application claims the benefit of U.S. Provisional Application Ser. No. 62/245,587 filed in the U.S. Patent Office on Oct. 23, 2015, and U.S. Provisional Application Ser. No. 62/333,069 filed in the U.S. Patent Office on May 6, 2016, the entire content of these applications being incorporated herein by reference and for all applicable purposes.

### BACKGROUND

Field

At least one aspect generally relates to data communications interfaces, and more particularly, to data communications interfaces configurable for communicating in multiple modes and/or speeds between integrated circuit devices.

Background

Manufacturers of mobile devices, such as cellular phones, may obtain components of the mobile devices from various sources, including different manufacturers. For example, the application processor in a cellular phone may be obtained from a first manufacturer, while the display for the cellular phone may be obtained from a second manufacturer. Moreover, multiple standards are defined for interconnecting certain components of the mobile devices. For example, there are multiple types of interface defined for communications between an application processor and display and camera components of a mobile device. Some components employ an interface that conforms to one or more standards specified by the Mobile Industry Processor Interface (MIPI) Alliance. For example, the MIPI Alliance defines protocols for a camera serial interface (CSI) and a display serial interface (DSI).

MIPI CSI-2 and MIPI DSI or DSI-2 standards define a wired interface between a camera and application processor, or an application processor and display. The low-level physical-layer (PHY) interface in each of these applications can be MIPI C-PHY or MIPI D-PHY. High-speed modes and low-power modes of communication are defined for MIPI C-PHY or MIPI D-PHY. The MIPI C-PHY high-speed mode uses a low-voltage multiphase signal transmitted in different phases on a 3-wire link. The MIPI D-PHY high-speed mode uses a plurality of 2-wire lanes to carry low-voltage differential signals. The low-power modes of MIPI C-PHY and MIPI D-PHY provide lower rates than the high-speed mode and transmits signals at higher voltages where the high-speed signals are undetectable by receivers configured for low-power operation.

As device technology improves, higher data rates and lower-power consumption may be obtained when devices are operated at lower voltage levels. There is a need to improve MIPI C-PHY and MIPI D-PHY interfaces to take advantage of technology improvements.

### SUMMARY

Embodiments disclosed herein provide systems, methods and apparatus that enable two or more Integrated Circuit (IC) devices to communicate bidirectionally using any of a plurality of interface standards, and in a high-speed mode and in a low-power mode. According to certain aspects described herein, two or more IC devices may be collocated in an electronic apparatus and communicatively coupled through one or more data links that can be configured with one of a plurality of interface standards.

In an aspect of the disclosure, a method performed in a device coupled to a multi-wire interface includes transmitting a sequence of signaling states on the multi-wire interface while operating in a low-power communication mode, where the sequence of signaling states are transmitted within a first voltage range is transmitted to cause a receiver to transition to a high-speed communication mode, transmitting first high-speed data over the multi-wire interface to the receiver while operating in the high-speed communication mode, where the first high-speed data is transmitted within a second voltage range that is less than the first voltage range, transmitting a control packet or control sequence of symbols over the multi-wire interface to the receiver while operating in the high-speed communication mode, where the control packet or control sequence of symbols is transmitted within the second voltage range that includes a sequence of symbols that is not used to encode data for transmission on the multi-wire interface, and receiving second high-speed data from the multi-wire interface after transmitting the control packet or control sequence of symbols and while operating in the high-speed communication mode, where the second high-speed data is received within the second voltage range.

In an aspect of the disclosure, an apparatus has a physical interface coupled to a 3-wire link, a mapper adapted to convert data to sequences of 3-phase symbols to be transmitted on the 3-wire link, and a processor. The processor may be configured to transmit a sequence of signaling states on the 3-wire link while operating in a low-power communication mode, where the sequence of signaling states are transmitted within a first voltage range is transmitted to cause a receiver to transition to a high-speed communication mode, transmit first high-speed data over the 3-wire link to the receiver while operating in the high-speed communication mode, where the first high-speed data is transmitted within a second voltage range that is less than the first voltage range, transmit a control packet or control sequence of symbols over the 3-wire link to the receiver while operating in the high-speed communication mode, where the control packet or control sequence of symbols is transmitted within the second voltage range that includes a sequence of symbols that is not used to encode data for transmission on the 3-wire link, and receive second high-speed data from the 3-wire link after transmitting the control packet or control sequence of symbols and while operating in the high-speed communication mode, where the second high-speed data is received within the second voltage range.

In an aspect of the disclosure, a processor readable storage medium has code stored thereon, including code for transmitting a sequence of signaling states on a multi-wire interface while operating in a low-power communication mode, where the sequence of signaling states are transmitted within a first voltage range is transmitted to cause a receiver to transition to a high-speed communication mode, transmitting first high-speed data over the multi-wire interface to the receiver while operating in the high-speed communication mode, where the first high-speed data is transmitted within a second voltage range that is less than the first voltage range, transmitting a control packet or control sequence of symbols over the multi-wire interface to the receiver while operating in the high-speed communication mode, where the control packet or control sequence of symbols is transmitted within the second voltage range that includes a sequence of symbols that is not used to encode data for transmission on the multi-wire interface, and receiving second high-speed data from the multi-wire interface after transmitting the control packet or control sequence of symbols and while operating in the high-speed communication mode, where the second high-speed data is received within the second voltage range.

In an aspect of the disclosure, an apparatus includes means for transmitting a sequence of signaling states on a multi-wire interface while operating in a low-power communication mode, where the sequence of signaling states are transmitted within a first voltage range is transmitted to cause a receiver to transition to a high-speed communication mode, means for transmitting first high-speed data over the multi-wire interface to the receiver while operating in the high-speed communication mode, where the first high-speed data is transmitted within a second voltage range that is less than the first voltage range, means for providing a control packet or control sequence of symbols to be transmitted over the multi-wire interface to the receiver while operating in the high-speed communication mode, where the control packet or control sequence of symbols is transmitted within the second voltage range that includes a sequence of symbols that is not used to encode data for transmission on the multi-wire interface, and means for receiving second high-speed data from the multi-wire interface after transmitting the control packet or control sequence of symbols and while operating in the high-speed communication mode, where the second high-speed data is received within the second voltage range.

### BRIEF DESCRIPTION OF THE DRAWINGS

FIG. 1 depicts an apparatus employing a data link between integrated circuit (IC) devices that selectively operates according to one of plurality of available standards.

FIG. 2 illustrates a system architecture for an apparatus employing a data link between IC devices.

FIG. 3 illustrates an example of a 3-phase polarity data encoder of a C-PHY interface.

FIG. 4 illustrates signaling in an example of a C-PHY interface.

FIG. 5 illustrates certain aspects of a receiver in a C-PHY interface.

FIG. 6 illustrates an example of a C-PHY interface adapted for symbol and/or symbol sequence insertion according to certain aspects disclosed herein.

FIG. 7 illustrates an example of signaling lanes that may be employed in a D-PHY interface.

FIG. 8 illustrates certain aspects of a configuration of drivers and receivers in a D-PHY interface.

FIG. 9 illustrates high-speed and low-power signaling in C-PHY and D-PHY interfaces.

FIG. 10 illustrates transitions between modes of communication and turnaround procedures in a C-PHY interface that may be adapted in accordance with certain aspects disclosed herein.

FIG. 11 illustrates a first example of fast bus turnaround in a C-PHY interface adapted in accordance with certain aspects disclosed herein.

FIG. 12 illustrates an example of fast bus turnaround in a D-PHY interface adapted in accordance with certain aspects disclosed herein.

FIG. 13 illustrates a second example of fast bus turnaround in a C-PHY interface adapted in accordance with certain aspects disclosed herein.

FIG. 14 illustrates additional examples of fast bus turnaround in a C-PHY interface adapted in accordance with certain aspects disclosed herein.

FIG. 15 illustrates an additional example of fast bus turnaround in a D-PHY interface adapted in accordance with certain aspects disclosed herein.

FIG. 16 illustrates a configurations of apparatus showing signals provided between elements of C-PHY and D-PHY interfaces adapted in accordance with certain aspects disclosed herein.

FIG. 17 is a diagram illustrating an example of an apparatus employing a processing circuit that may be adapted according to certain aspects disclosed herein.

FIG. 18 is a flow chart of a data transfer method operational on one of two devices in an apparatus.

FIG. 19 is a diagram illustrating an example of a hardware implementation for an apparatus employing a processing employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of data communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

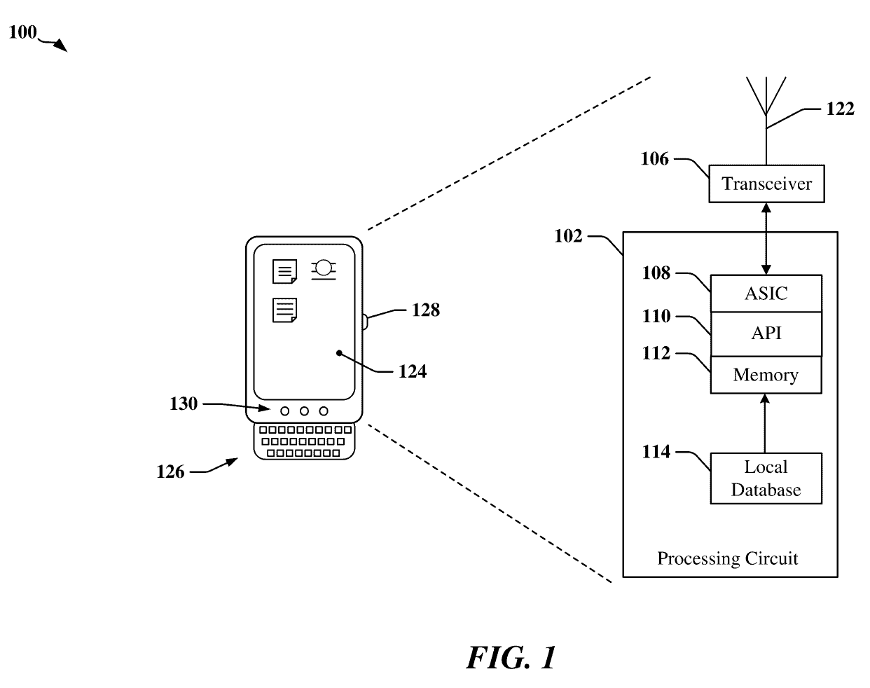

FIG. 1 depicts an apparatus 100 that may employ a communication link between IC devices. In one example, the apparatus 100 may include a communication device that communicates through a radio frequency (RF) communications transceiver 106 with a radio access network (RAN), a core access network, the Internet and/or another network. The communications transceiver 106 may be operably coupled to a processing circuit 102. The processing circuit 102 may include one or more IC devices, such as an application-specific IC (ASIC) 108. The ASIC 108 may include one or more processing devices, logic circuits, and so on. The processing circuit 102 may include and/or be coupled to processor readable storage such as a memory device 112 that can store and maintain data and instructions for execution or other use by the processing circuit 102. The processing circuit 102 may be controlled by one or more of an operating system and an application programming interface (API) 110 layer that supports and enables execution of software modules residing in storage media, such as the memory device 112 of the device. The memory device 112 may include ROM or RAM, EEPROM, flash cards, or any memory device that can be used in processing systems and computing platforms. The processing circuit 102 may include or access a local database 114 that can maintain operational parameters and other information used to configure and operate the apparatus 100. The local database 114 may be implemented using one or more of a database module, flash memory, magnetic media, EEPROM, optical media, tape, soft or hard disk, or the like. The processing circuit may also be operably coupled to external devices such as an antenna 122, a display 124, operator controls, such as a button 128 and a keypad 126 among other components.

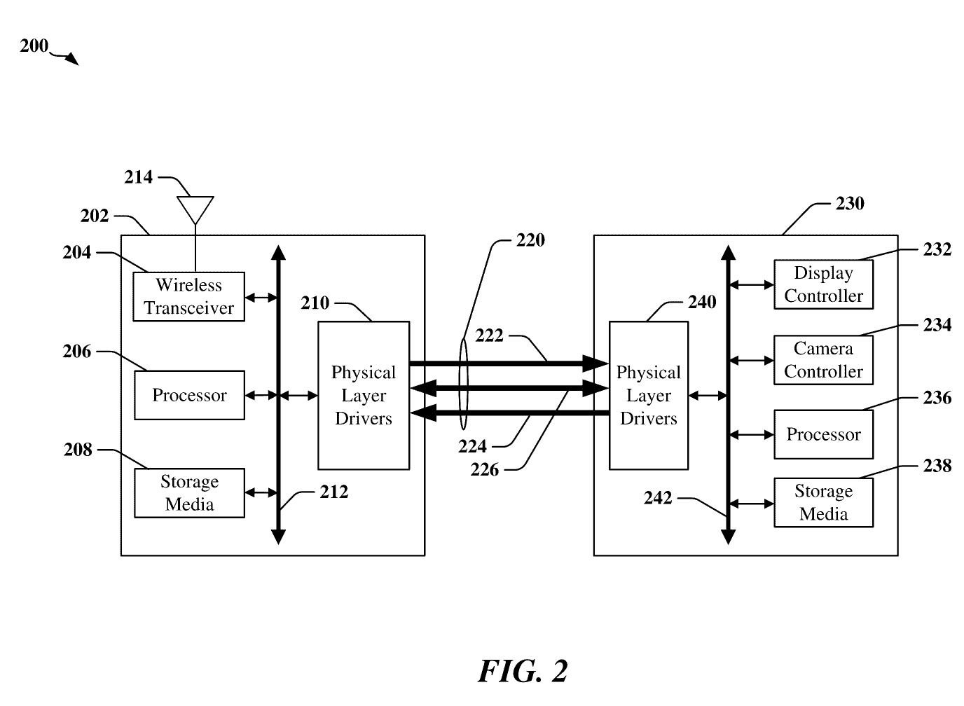

FIG. 2 is a block schematic diagram illustrating certain aspects of an apparatus 200 such as a mobile apparatus that employs a communication link 220 to connect various subcomponents. In one example, the apparatus 200 includes a plurality of IC devices 202 and 230 that exchange data and control information through the communication link 220. The communication link 220 may be used to connect IC devices 202 and 230 that are located in close proximity to one another, or physically located in different parts of the apparatus 200. In one example, the communication link 220 may be provided on a chip carrier, substrate or circuit board that carries the IC devices 202 and 230. In another example, a first IC device 202 may be located in a keypad section of a mobile computing device while a second IC device 230 may be located in a display section of mobile computing device. In another example, a portion of the communication link 220 may include a cable or optical connection.

The communication link 220 may provide multiple channels 222, 224 and 226. One or more channels 226 may be bidirectional, and may operate in half-duplex and/or full-duplex modes. One or more channels 222 and 224 may be unidirectional. The communication link 220 may be asymmetrical, providing higher bandwidth in one direction. In one example described herein, a first channel may be referred to as a forward channel 222 while a second channel may be referred to as a reverse channel 224. The first IC device 202 may be designated as a host system or transmitter, while the second IC device 230 may be designated as a client system or receiver, even if both IC devices 202 and 230 are configured to transmit and receive on the forward channel 222. In one example, the forward channel 222 may operate at a higher data rate when communicating data from a first IC device 202 to a second IC device 230, while the reverse channel 224 may operate at a lower data rate when communicating data from the second IC device 230 to the first IC device 202.

The IC devices 202 and 230 may each have a processor or other processing and/or computing circuit or device 206, 236. In one example, the first IC device 202 may perform core functions of the apparatus 200, including maintaining communications through an RF transceiver 204 and an antenna 214, while the second IC device 230 may support a user interface that manages or operates a display controller 232. In the example, the second IC device 230 may be adapted to control operations of a camera or video input device using a camera controller 234. Other features supported by one or more of the IC devices 202 and 230 may include a keyboard, a voice-recognition component, and other input or output devices. The display controller 232 may include circuits and software drivers that support displays such as a liquid crystal display (LCD) panel, touch-screen display, indicators and so on. The storage media 208 and 238 may include transitory and/or non-transitory storage devices adapted to maintain instructions and data used by respective processors 206 and 236, and/or other components of the IC devices 202 and 230. Communication between each processor 206, 236 and its corresponding storage media 208 and 238 and other modules and circuits may be facilitated by one or more bus 212 and 242, respectively.

The reverse channel 224 may be operated in the same manner as the forward channel 222, and the forward channel 222 and reverse channel 224 may be capable of transmitting at comparable speeds or at different speeds, where speed may be expressed as data transfer rate and/or clocking rates. The forward and reverse data rates may be substantially the same or differ by orders of magnitude, depending on the application. In some applications, a single bidirectional channel 226 may support communications between the first IC device 202 and the second IC device 230. The forward channel 222 and/or reverse channel 224 may be configurable to operate in a bidirectional mode when, for example, the forward channel 222 and reverse channel 224 share the same physical connections and operate in a half-duplex manner. In one example, the communication link 220 may be operated to communicate control, command and other information between the first IC device 202 and the second IC device 230 in accordance with an industry or other standard.

In some instances, the forward channel 222 and/or reverse channel 224 may be configured or adapted to support a wide video graphics array (WVGA) 80 frames per second LCD driver IC without a frame buffer, delivering pixel data at 810 Mbps for display refresh. In another example, the forward channel 222 and/or reverse channel 224 may be configured or adapted to enable communications between with dynamic random access memory (DRAM), such as double data rate synchronous dynamic random access memory (SDRAM). The drivers 210, 240 may include encoding devices that can be configured to encode multiple bits per clock transition, and multiple sets of wires can be used to transmit and receive data from the SDRAM, control signals, address signals, and other signals.

The forward channel 222 and/or reverse channel 224 may comply with, or be compatible with application-specific industry standards. In one example, the MIPI standard defines physical layer interfaces between an application processor IC device 202 and an IC device 230 that supports the camera or display in a mobile device. The MIPI standard includes specifications that govern the operational characteristics of products that comply with MIPI specifications for mobile devices. In some instances, the MIPI standard may define interfaces that employ complimentary metal-oxide-semiconductor (CMOS) parallel busses.

The MIPI Alliance defines standards and specifications that may address communications affecting all aspects of operations in a mobile device, including the antenna, peripherals, the modem and application processors. For example, the MIPI Alliance defines protocols for a camera serial interface (CSI) and a display serial interface (DSI). The MIPI CSI-2 defines a wired interface between a camera and Application Processor and the MIPI DSI or DSI-2 defines a wired interface between an Application Processor and a display. The low-level physical layer (PHY) interface in each of these applications can be MIPI C-PHY or MIPI D-PHY.

MIPI C-PHY Interface

According to certain aspects disclosed herein, systems and apparatus may employ multi-phase data encoding and decoding interface methods for communicating between IC devices 202 and 230. A multi-phase encoder may drive a plurality of conductors (i.e., M conductors). The M conductors typically include three or more conductors, and each conductor may be referred to as a wire, although the M conductors may include conductive traces on a circuit board or within a conductive layer of a semiconductor IC device. In one example, the MIPI Alliance-defined “C-PHY” physical layer interface technology may be used to connect camera and display devices 230 to an application processor device 202. The C-PHY interface employs three-phase symbol encoding to transmit data symbols on 3-wire lanes, or “trios” where each trio includes an embedded clock.

The M conductors may be divided into a plurality of transmission groups, each group encoding a portion of a block of data to be transmitted. An N-phase encoding scheme is defined in which bits of data are encoded in phase transitions and polarity changes on the M conductors. Decoding does not rely on independent conductors or pairs of conductors and timing information can be derived directly from phase and/or polarity transitions in the M conductors. N-Phase polarity data transfer can be applied to any physical signaling interface, including electrical, optical and radio frequency (RF) interfaces.

In the C-PHY example, a three-phase encoding scheme for a three-wire system may define a signal that can switch between three phase states and two polarities, providing 6 states and 5 possible transitions from each state. Deterministic voltage and/or current changes may be detected and decoded to extract data from the three wires.

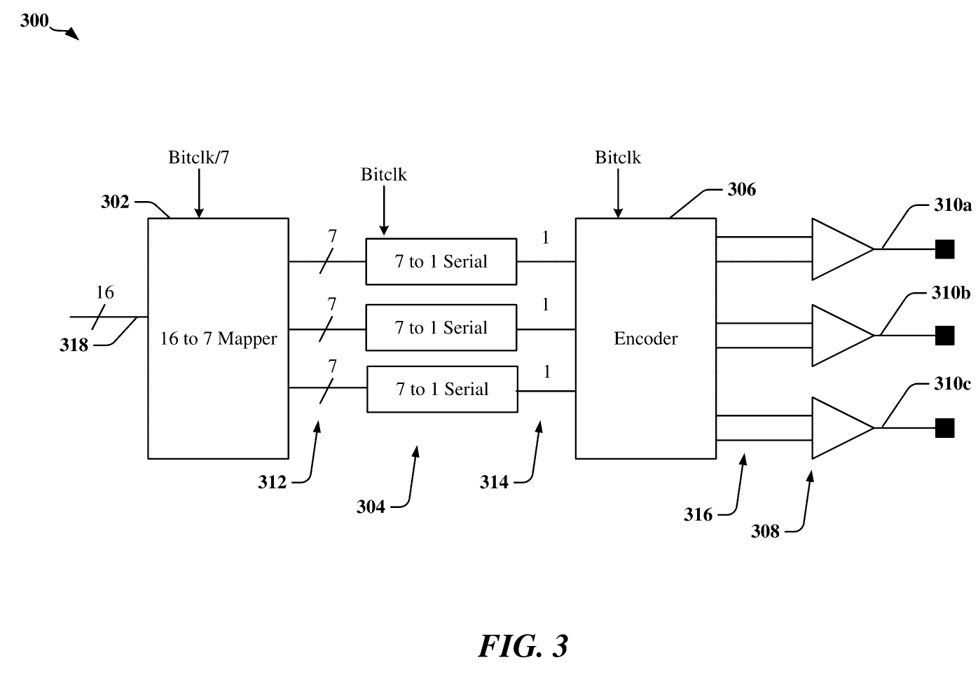

FIG. 3 is a schematic diagram illustrating the use of N-phase polarity encoding to implement certain aspects of the communication link 220 depicted in FIG. 2. The illustrated example relates to a three-wire link or to a three-wire lane or portion of a link that has more than three wires. The communication link 220 may include a wired bus having a plurality of signal wires, which may be configured to carry three-phase encoded data in a high-speed digital interface, such as a mobile display digital interface (MDDI). One or more of the channels 222, 224 and 226 may be configured or adapted to use three-phase polarity encoding. The physical layer drivers 210 and 240 may be adapted to encode and decode three-phase polarity encoded data transmitted on link 220. The use of 3-phase polarity encoding provides for high-speed data transfer and may consume half or less of the power of other interfaces because fewer than 3 drivers are active in 3-phase polarity encoded data links 220 at any time. 3-phase polarity encoding circuits in the physical layer drivers 210 and/or 240 can encode multiple bits per transition on the communications link 220. In one example, a combination of three-phase encoding and polarity encoding may be used to support a wide video graphics array (WVGA), 80 frames per second LCD driver IC without a frame buffer, delivering pixel data for display refresh at 810 Mbps over three or more wires.

In the depicted C-PHY example 300, an M-wire, N-phase polarity encoding transmitter is configured for M=3 and N=3. The example of three-wire, three-phase encoding is selected solely for the purpose of simplifying descriptions of certain aspects of this disclosure. The principles and techniques disclosed for three-wire, three-phase encoders can be applied in other configurations of M-wire, N-phase polarity encoders, and may comply or be compatible with other interface standards.

When three-phase polarity encoding is used, connectors such as signal wires 310a, 310b and 310c on a 3-wire bus may be undriven, driven positive, or driven negative. An undriven signal wire 310a, 310b or 310c may be in a high-impedance state. An undriven signal wire 310a, 310b or 310c may be driven or pulled to a voltage level that lies substantially halfway between the positive and negative voltage levels provided on driven signal wires. An undriven signal wire 310a, 310b or 310c may have no current flowing through it. In the example 300, each signal wire 310a, 310b and 310c may be in one of three states (denoted as +1, −1, or 0) using drivers 308. In one example, drivers 308 may include unit-level current-mode drivers. In another example, drivers 308 may drive opposite polarity voltages on two signals transmitted on the signal wires 310a and 310b while the third signal wire 310c is at high impedance and/or pulled to ground. For each transmitted symbol interval, at least one signal is in the undriven (0) state, while the number of signals driven positive (+1 state) is equal to the number of signals driven negative (−1 state), such that the sum of current flowing to the receiver is always zero. For each symbol, the state of at least one signal wire 310a, 310b or 310c is changed from the symbol transmitted in the preceding transmission interval.

In the example, 300, a mapper 302 may receive 16-bit input data 318, and the mapper 302 may map the input data 318 to 7 symbols 312 for transmitting sequentially over the signal wires 310a, 310b and 310c. An M-wire, N-phase encoder 306 configured for three-wire, three-phase encoding receives the 7 symbols 312 produced by the mapper one input symbol 314 at a time and computes the state of each signal wire 310a, 310b and 310c for each symbol interval, based on the immediately preceding state of the signal wires 310a, 310b and 310c. The 7 symbols 312 may be serialized using parallel-to-serial converters 304, for example. The encoder 306 selects the states of the signal wires 310a, 310b and 310c based on the input symbol 314 and the previous states of signal wires 310a, 310b and 310c.

The use of M-wire, N-phase encoding permits a number of bits to be encoded in a plurality of symbols where the bits per symbol is not an integer. In the simple example of a three-wire, three-phase system, there are 3 available combinations of 2 wires, which may be driven simultaneously, and 2 possible combinations of polarity on any pair of wires that is driven simultaneously, yielding 6 possible states. Since each transition occurs from a current state, 5 of the 6 states are available at every transition. The state of at least one wire is typically required to change at each transition. With 5 states, log₂(5)≅2.32 bits may be encoded per symbol. Accordingly, a mapper may accept a 16-bit word and convert it to 7 symbols because 7 symbols carrying 2.32 bits per symbol can encode 16.24 bits. In other words, a combination of seven symbols that encodes five states has 5⁷ (78,125) permutations. Accordingly, the 7 symbols may be used to encode the 2¹⁶ (65,536) permutations of 16 bits.

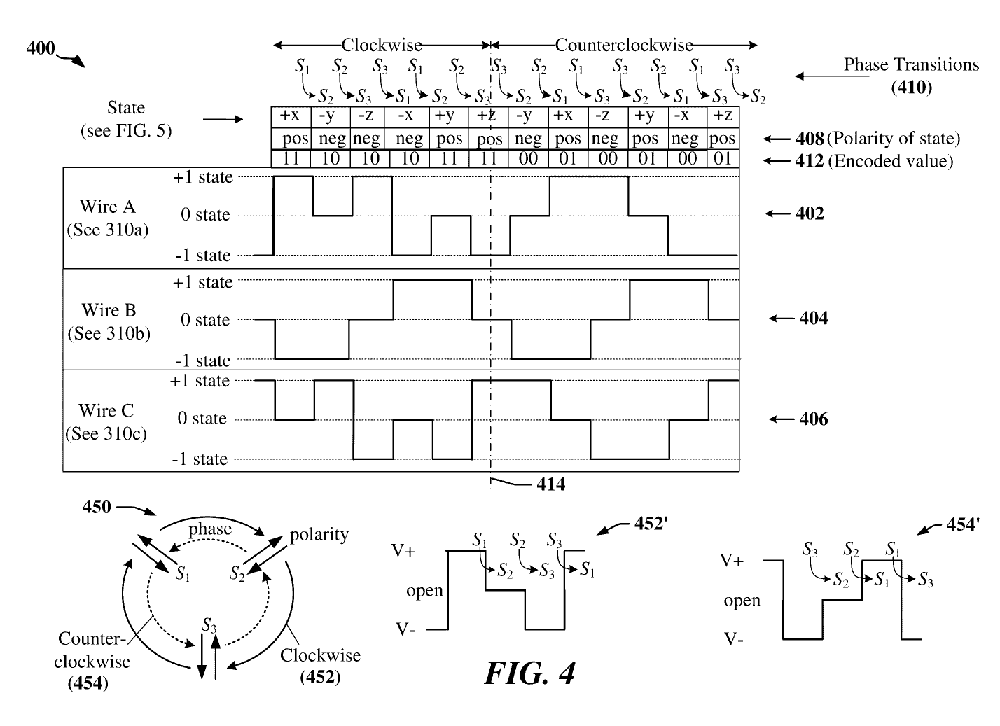

FIG. 4 illustrates an example of signaling 400 employing a three-phase modulation data-encoding scheme based on the circular state transition diagram 450. According to the data-encoding scheme, a three-phase signal may rotate in two directions and may be transmitted on three signal wires 310a, 310b and 310c. Each of the three signals is independently driven on the signal wires 310a, 310b, 310c. Each of the three signals includes the three-phase signal, with each signal being 120 degrees out of phase relative to the other two signals. At any point in time, each of the three signal wires 310a, 310b, 310c is in a different one of the states {+1, 0, −1}. At any point in time, each of the three signal wires 310a, 310b, 310c in a 3-wire system is in a different state than the other two wires. When more than three conductors or wires are used, two or more pairs of wires may be in the same state. The illustrated encoding scheme may also encode information in the polarity of the two signal wires 310a, 310b and/or 310c that are actively driven to the +1 and −1 states. Polarity is indicated at 408 for the sequence of states depicted.

At any phase state in the illustrated three-wire example, exactly two of the signal wires 310a, 310b, 310c carry a signal which is effectively a differential signal for that phase state, while the third signal wire 310a, 310b or 310c is undriven. The phase state for each signal wire 310a, 310b, 310c may be determined by voltage difference between the signal wire 310a, 310b or 310c and at least one other signal wire 310a, 310b and/or 310c, or by the direction of current flow, or lack of current flow, in the signal wire 310a, 310b or 310c. As shown in the state transition diagram 450, three phase states (S₁, S₂ and S₃) are defined. A signal may flow clockwise from phase state S₁ to phase state S₂, phase state S₂ to phase state S₃, and/or phase state S₃ to phase state S₁ and the signal may flow counter-clockwise from phase state S₁ to phase state S₃, phase state S₃ to phase state S₂, and/or phase state S₂ to phase state S₁. For other values of N, transitions between the N states may optionally be defined according to a corresponding state diagram to obtain circular rotation between state transitions.

In the example of a three-wire, three-phase communications link, clockwise rotations (S₁ to S₂), (S₂ to S₃), and/or (S₃ to S₁) at a state transition 410 may be used to encode a logic 1, while counter-clockwise rotations (S₁ to S₃), (S₃ to S₂), and/or (S₂ to S₁) at the state transition 410 may be used to encode a logic 0. Accordingly, a bit may be encoded at each transition by controlling whether the signal is “rotating” clockwise or counter-clockwise. For example, a logic 1 may be encoded when the three signal wires 310a, 310b, 310c transition from phase state S₁ to phase state S₂ and a logic 0 may be encoded when the three signal wires 310a, 310b, 310c transition from phase state S₁ to phase state S₃. In the simple three-wire example depicted, direction of rotation may be easily determined based on which of the three signal wires 310a, 310b, 310c is undriven before and after the transition.

Information may also be encoded in the polarity and/or changes of polarity of state 408 of the driven signal wires 310a, 310b, 310c, or in the direction of current flow or changes in the direction of current flow between two signal wires 310a, 310b, 310c. Signals 402, 404, and 406 illustrate voltage levels applied to signal wires 310a, 310b, 310c, respectively at each phase state in a three-wire, three-phase link. At any time, a first signal wire 310a, 310b, 310c is coupled to a more positive voltage (+V, for example), a second signal wire 310a, 310b, 310c is coupled to a more negative voltage (−V, for example), while the third signal wire 310a, 310b, 310c may be open-circuited. As such, one polarity encoding state may be determined by the current flow between the first and second signal wires 310a, 310b, 310c or the voltage polarities of the first and second signal wires 310a, 310b, 310c. In some embodiments, two bits of data 412 may be encoded in each state transition 410. A decoder may determine the direction of signal phase rotation to obtain the first bit. The second bit may be determined based on the polarity difference between two of the signals 402, 404 and 406. In some instances, the second bit may be determined based on a change or lack of change in polarity of the differential signal transmitted on a pair of the signal wires 310a, 310b, 310c. The decoder having determined direction of rotation can determine the phase state and the polarity of the voltage applied between the two active signal wires 310a, 310b and/or 310c, or the direction of current flow through the two active signal wires 310a, 310b and/or 310c.

In the example of the three-wire, three-phase link described herein, one bit of data may be encoded in the rotation, or phase change in the three-wire, three-phase link, and an additional bit may be encoded in the polarity or changes in polarity of two driven wires. Certain embodiments, encode more than two bits in each transition of a three-wire, three-phase encoding system by allowing transition to any of the possible states from a current state. Given three rotational phases and two polarities for each phase, 6 states are defined, such that 5 states are available from any current state. Accordingly, there may be log₂(5)≅2.32 bits per symbol (transition) and the mapper may accept a 16-bit word and convert it to 7 symbols. In other words, a three-wire, three-phase C-PHY link may map 16 bits of input data 318 to the 7 symbols 312.

In other examples, an encoder may transmit symbols using 6 wires with two pairs of wires driven for each state. The 6 wires may be labeled A through F, such that in one state, wires A and F are driven positive, wires B and E negative, and C and D are undriven (or carry no current). For six wires, there may be:

$$C ( 6 , 4 ) = \frac{6 !}{( 6 - 4 ) ! \cdot 4 !} = 15$$

possible combinations of actively driven wires, with:

$$C ( 4 , 2 ) = \frac{4 !}{( 4 - 2 ) ! \cdot 2 !} = 6$$

different combinations of polarity for each phase state.

The 15 different combinations of actively driven wires may include:

| | | | | |
|---|---|---|---|---|
| A B C D | A B C E | A B C F | A B D E | A B D F |
| A B E F | A C D E | A C D F | A C E F | A D E F |
| B C D E | B C D F | B C E F | B D E F | C D E F |

Of the 4 wires driven, the possible combinations of two wires driven positive (and the other two must be negative). The combinations of polarity may include:

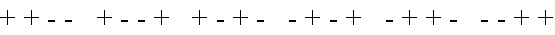

Accordingly, the total number of different states may be calculated as 15×6=90. To guarantee a transition between symbols, 89 states are available from any current state, and the number of bits that may be encoded in each symbol may be calculated as: log₂(89)≅6.47 bits per symbol. In this example, a 32-bit word can be encoded by the mapper into 5 symbols, given that 5×6.47=32.35 bits.

The general equation for the number of combinations of wires that can be driven for a bus of any size, as a function of the number of wires in the bus and number of wires simultaneously driven:

$$C ( {N}_{wires} , {N}_{driven} ) = \frac{{N}_{wires} !}{( {N}_{wires} - {N}_{driven} ) ! \cdot {N}_{driven} !}$$

The equation for the number of combinations of polarity for the wires being driven is:

$$C ( {N}_{driven} , \frac{{N}_{driven}}{2} ) = \frac{{N}_{driven} !}{{( ( \frac{{N}_{driven}}{2} ) ! )}^{2}}$$

The number of bits per symbol is:

$${log}_{2} ( C ( {N}_{wires} , {N}_{driven} ) \cdot C ( {N}_{driven} , \frac{{N}_{driven}}{2} ) - 1 ) .$$

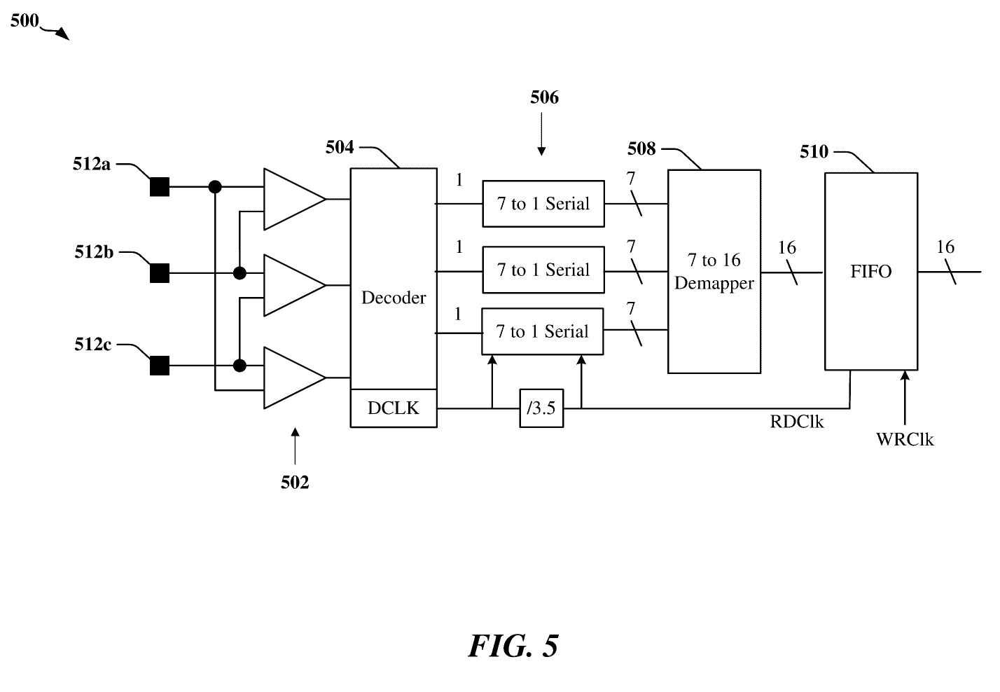

FIG. 5 illustrates an example 500 of a receiver in a three-wire, three-phase PHY. The three-wire, three-phase example is illustrative of certain principles of operation applicable to other configurations of M-wire, N-phase receivers. Comparators 502 and decoder 504 are configured to provide a digital representation of the state of each of three transmission lines 512a, 512b and 512c, as well as the change in the state of the three transmission lines compared to the state transmitted in the previous symbol period. Seven consecutive states are assembled by serial-to-parallel converters 506 to produce a set of 7 symbols to be processed by a demapper 508 to obtain 16 bits of data that may be buffered in a first-in-first-out (FIFO) storage device 510, which may be implemented using registers, for example.

According to certain aspects disclosed herein, a plurality of three-state amplifiers can be controlled to produce a set of output states defined by a differential encoder, an N-phase polarity encoder, or another encoder that encodes information in wires or connectors that can assume one of the three states described.

With reference again to FIGS. 2 and 3, the communication link 220 may include a high-speed digital interface that can be configured to support both differential encoding scheme and N-phase polarity encoding. Physical layer drivers 210 and 240 may include N-phase polarity encoders and decoders, which can encode multiple bits per transition on the interface, and line drivers to drive signal wires 310a, 310b and 310c. The line drivers may be constructed with amplifiers that produce an active output that can have a positive or negative voltage, or a high impedance output whereby a signal wires 310a, 310b or 310c is in an undefined state or a state that is defined by external electrical components. Accordingly, the output drivers 308 may receive by a pair of signals 316 that includes data and output control (high-impedance mode control). In this regard, the three-state amplifiers used for N-phase polarity encoding and differential encoding can produce the same or similar three output states.

MIPI C-PHY Interface with Symbol Sequence Substitution

According to certain aspects disclosed herein, a sequence of 7 symbols 312 (see FIG. 3) may be modified to implement control signals and/or commands received from upper higher layers of a C-PHY protocol. In one example, one or more sequence of 7 symbols 312 may be replaced after mapping by the mapper 302. In another example, a substitute sequence of 7 symbols 312 may be inserted into the stream of symbols that encodes data. In another example, incomplete and/or variable length sequences of symbols or a single symbol may be inserted into the stream of symbols that encodes data.

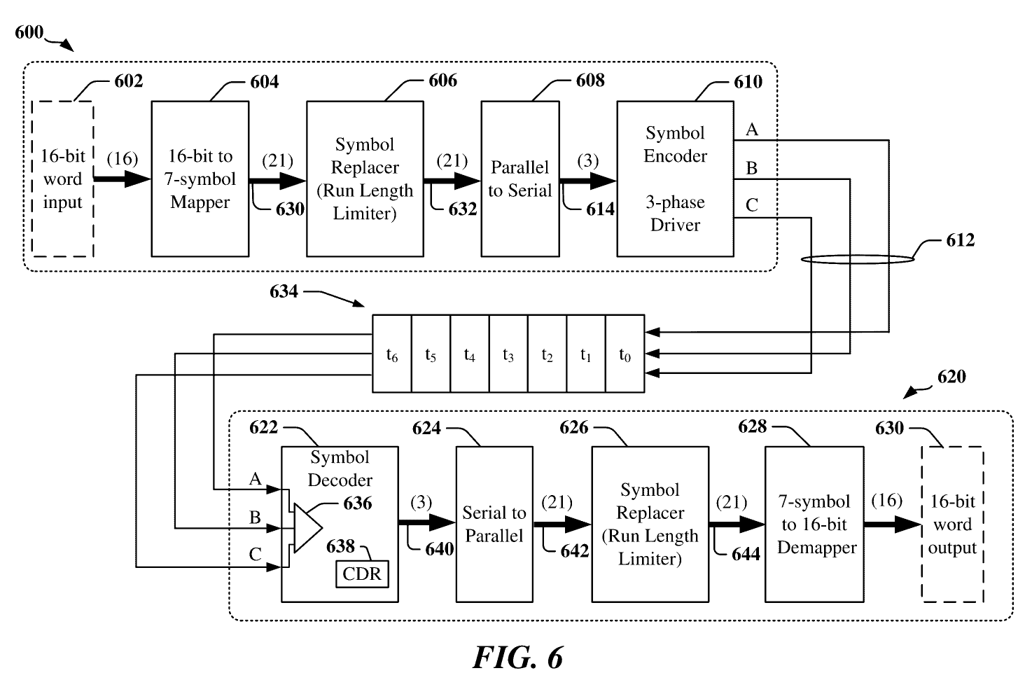

FIG. 6 is a diagram illustrating an example of a transmitter 600 and a receiver 620 that can be configured to substitute sequence of symbols received from a mapper 604 that may otherwise violate a run-length limit configured for a C-PHY interface. In one example, a symbols replacer 606 may also be used to avoid signaling issues, such as run-length issues in a 3-wire, 3-phase C-PHY interface, which may arise when one or more wires remain in the same signaling state for an excessive number of successive symbols. In a C-PHY interface, conventional mapping and encoding can produce consecutive states on the trio of wires such that one of the wires remains in the same state for many consecutive symbols. When one of the three wires is held at a constant value for too long, certain undesirable effects may result, including increased inter-symbol interference (ISI). The number of consecutive states in which a wire has the same value (voltage or current flow) may be referred to as “run-length” and a run-length of N may describe a condition in which a wire remains in the same voltage or current state for N symbols. Prolonged run-lengths may affect the switching time as capacitances accumulate charge and/or as current builds in inductances. Increased switching times can lead to constraints on maximum symbol frequency because the time during which the wires of a C-PHY interface are stable and available for sampling is reduced.

The symbol replacer 606 may ameliorate or prevent run-length issues. At the transmitter 600, 16-bit words 602 are received as the input to the mapper 604. The mapper 604 converts each of the 16-bit words 602 to seven symbols in a set of symbols 614 to be transmitted sequentially over a 3-wire link 612. The set of symbols 614 may be provided as a group of 21 bits organized as seven 3-bit symbols. The set of symbols 614 may be provided to a symbol replacer 606 configured to limit run-length by selectively substituting certain sets of symbols 614 received from the mapper 604 with a replacement set of symbols. This symbol replacer provides a selectively modified group of bits 616 to a parallel-to-serial converter 608 that produces a time-sequence of 3-bit symbols 618 to a symbol encoder 610, which defines the state of the three wires (labeled A, B and C) of the 3-wire link 612 in each of a sequence of symbol transmission intervals 634.

In a C-PHY interface, up to 12,589 sequences of symbols may be unused by the mapper 604 and these unused can be available to the symbol replacer 606 for substitutions and insertions. The unused sequences of symbols are available because the mapper 604 maps 65,536 possible values of 16-bit words 602 to a 65,536 of the 78,125 possible permutations of sequences of phase and polarity for the three wires.

At the receiver 620, a symbol decoder 622 may include a set of differential receivers 636 and a CDR 638, which may cooperate to produce a receiver clock and decode a sequence of seven raw 3-bit symbols 640 based on the signaling states and transitions in signaling state of the three wires of the 3-wire link 612 during the sequence of symbol transmission intervals 634. The receiver 620 may include a serial-to-parallel convertor 624 that converts the sequence of seven raw symbols 640 to a group of 21 bits 642 organized as seven 3-bit symbols. A reverse symbol replacer 626 may be adapted or configured to receive the set of 21 bits 642 and to produce a modified set of 21 bits 644 after reversing symbol substitutions that may have been performed by the symbol replacer 606 in the transmitter 600. The reverse symbol replacer 626 may be configured to identify sequences of symbols in the 12,589 sequences of symbols that are not used by the mapper 604, and to perform a predefined substitution as needed. The demapper 628 may convert the 7 symbols in the modified set of 21 bits 644 to a 16-bit word 630, which may be provided as an output of the receiver 620. Each symbol detected by the receiver 620 can be represented using a 3-bit raw symbol value, having one of five possible values: 000, 001, 010, 011 and 100. The value of the raw symbol value is defined by: {Same_Phase, delta_Phase, delta_Polarity}. Each of the three bits represents a change or no change from the previous wire state to the present wire state.

The symbol replacers 606 and 626 may be incorporated in the mapper 604 and demapper 628, respectively, and/or may be provided as distinct components. The symbol replacer 606 in the transmitter 600 may be employed to perform a variety of substitutions or insertions using surplus symbols.

MIPI D-PHY Interface

According to certain aspects disclosed herein, systems and apparatus may employ some combination of differential and single-ended encoding for communicating between IC devices 202 and 230. In one example, the MIPI Alliance-defined “D-PHY” physical layer interface technology may be used to connect camera and display devices 230 to an application processor device 202. The D-PHY interface can switch between a differential (High-speed) mode and a single-ended (Low Power) mode in real time as needed to facilitate the transfer of large amounts of data or to conserve power and prolong battery life. The D-PHY interface is capable of operating in simplex or duplex configuration with single data lane or multiple data lanes with a unidirectional (Master to Slave) clock lane.

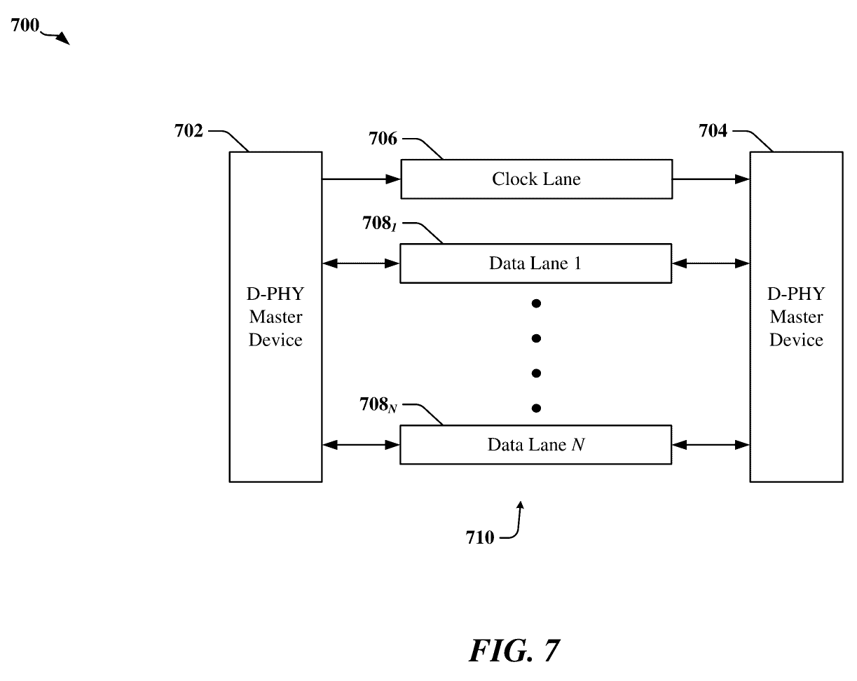

FIG. 7 illustrates a generalized D-PHY configuration 700 that includes a master device 702 and a slave device 704. The master device 702 generates clock signals that control transmissions on the wires 710. A clock signal is transmitted on a clock lane 706 and data is transmitted in one or more data lanes 708₁-708_{N}. The number of data lanes 708₁-708_{N} that are provided or active in a device may be dynamically configured based on application needs, volumes of data to be transferred and power conservation needs.

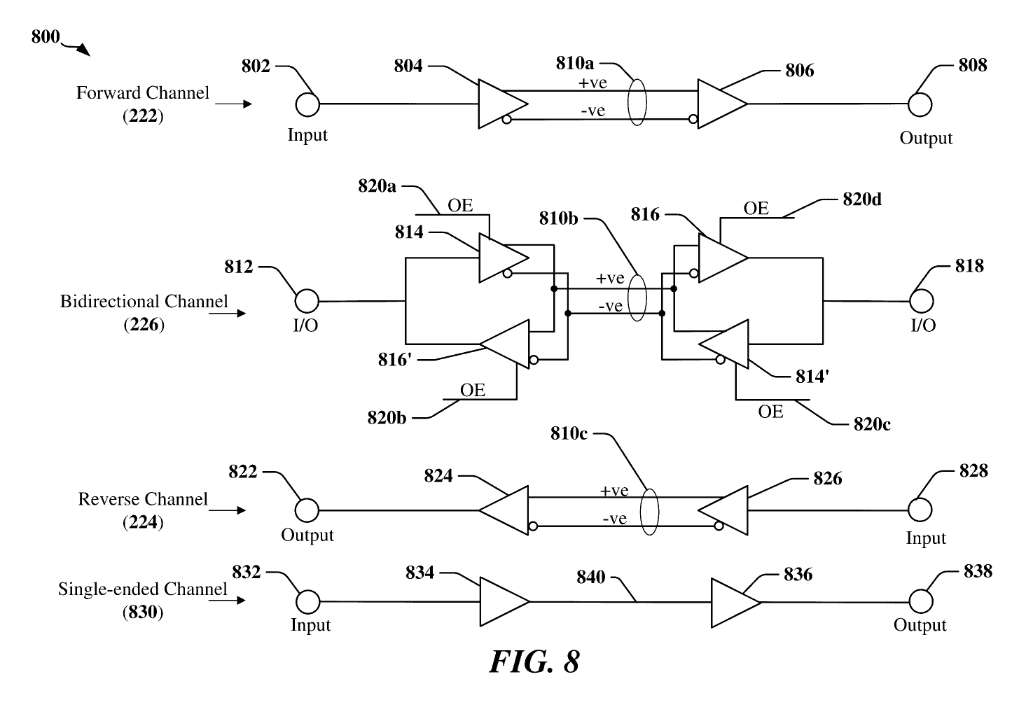

FIG. 8 is a schematic diagram 800 illustrating differential signaling that may be employed in a D-PHY implementation of the communication link 220 (see FIG. 2). Differential signaling typically involves transmitting information electrically using two complementary signals sent on a pair of wires 810a, 810b or 810c, which may be referred to as a differential pair. The use of differential pairs can significantly reduce electromagnetic interference (EMI) by canceling the effect of common-mode interference that affects both wires in a differential pair. On the forward channel 222, a pair of wires 810a may be driven by a host differential driver 804. The differential driver 804 receives a stream of input data 802 and generates positive and negative versions of the input data 802, which are then provided to the pair of wires 810a. The differential receiver 806 on the client side generates an output data stream 808 by performing a comparison of the signals carried on the pair of wires 810a.

On the reverse channel 224, one or more pairs of wires 810c may be driven by a client-side differential driver 826. The differential driver 826 receives a stream of input data 828 and generates positive and negative versions of the input data 828, which are provided to the pair of wires 810c. The differential receiver 824 on the host generates an output data stream 822 by performing a comparison of the signals carried on the pair of wires 810c.

In a bidirectional channel 226, the host and client may be configured for half-duplex mode and may transmit and receive data on the same pair of wires 810b. A bidirectional bus may alternatively or additionally be operated in full-duplex mode using combinations of the forward and reverse differential drivers 804, 826 to drive multiple pairs of wires 810a, 810c. In the half-duplex bidirectional implementation depicted for the bidirectional channel 226, the differential drivers 814 and 814′ may be prevented from driving the pair of wires 810b simultaneously using, for example, an output enable (OE) control 820a, 820c (respectively) to force the differential drivers 814 and 814′ into a high impedance state. The differential receiver 816′ may be prevented from driving the input/output 812 while the differential driver 814 is active, typically using an OE control 820b to force the differential receiver 816′ into a high impedance state. The differential receiver 816 may be prevented from driving the input/output 818 while the differential driver 814′ is active, typically using an OE control 820d to force the differential receiver 816 into a high impedance state. In some instances, the outputs of the differential drivers 814 and 814′ and the differential receivers 816 and 816′ may be in a high-impedance state when the interface is not active. Accordingly, the OE controls 820a, 820c, 820b and 820c of the differential drivers 814, 814′, and the differential receivers 816 and 816′ may be operated independently of one another.

Each of the differential drivers 804, 814, 814′ and 826 may include a pair of amplifiers, one receiving at one input the inverse of the input of the other amplifier. The differential drivers 804, 814, 814′ and 826 may each receive a single input and may have an internal inverter that generates an inverse input for use with a pair of amplifiers. The differential drivers 804, 814, 814′ and 826 may also be constructed using two separately controlled amplifiers, such that their respective outputs can be placed in high impedance mode independently of one another.

When a D-PHY implementation of the communication link 220 (see FIG. 2) is operated in Low Power mode, signals may be transmitted on single wire data and/or clock lanes. In one example, the differential drivers 804, 814, and/or 826 may be reconfigured or controlled such that only one of the wires in a pair of wires 810a, 810b or 810c of an active lane is driven. In other examples, the differential drivers 804, 814, and/or 826 may be turned off or placed in a high-impedance output mode, and separate, single-ended line driver 834 and receiver 836 may be used for communications over a single-wire, single-ended link 840. In some instances, the input 832 and output 838 of the single-ended link 840 may be bidirectional, and both transmitting and receiving devices may employ a transceiver that includes both a line driver 834 and a receiver 836 that is controlled in accordance with one or more protocols.

Low-Voltage, Lower-Power Mode in C-PHY and D-PHY Interfaces

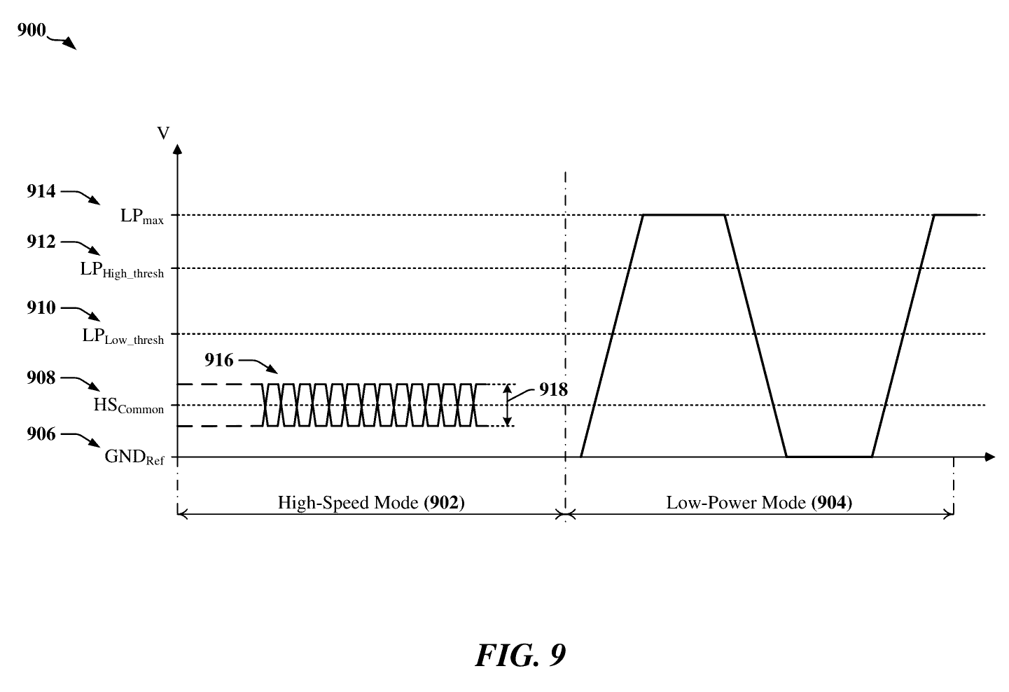

FIG. 9 is a graphical representation 900 of waveforms illustrating certain aspects of signaling in D-PHY and C-PHY interfaces. The D-PHY and C-PHY interfaces support a high-speed communication mode 902 and a low-power communication mode 904. Data is transmitted at a significantly lower rate in the low-power communication mode 904 than in the high-speed communication mode 902. The high-speed communication mode 902 and the low-power communication mode 904 operate at different voltage levels and voltage ranges when transmitting signal using the same wires of a serial bus.

In the high-speed communication mode 902, signals are centered on a high-speed common (HS_{Common}) voltage level 908, which is offset from a reference ground voltage level 906. Signals in the high-speed communication mode 902 have a voltage range 918 that ensures that high-speed signals 916 do not exceed a logic low threshold voltage level (LP_{Low}_{_}ₜₕᵣₑₛₕ) 910, which defines the upper limit for logic low in the low-power communication mode 904. In one D-PHY example, the HS_{Common} voltage level 908 may be nominally defined to be 200 millivolts (mV), and the voltage range 918 for high-speed signals may be nominally defined to be 200 mV. In one C-PHY example, the HS_{Common} voltage level 908 may be nominally defined to be 250 millivolts (mV), and the voltage range 918 for high-speed signals may be nominally defined to be 250 mV.

In the low-power communication mode 904, signals switch between a maximum low-power (LPₘₐₓ) voltage level 914 and the reference ground voltage level 906. The logic low voltage levels LP_{Low}_{_}ₜₕᵣₑₛₕ 910 and the logic high threshold voltage level (LP_{High}_{_}ₜₕᵣₑₛₕ) 912 define the switching voltage levels for high-to-low transitions and low-to high transitions, respectively. In one example, the maximum low-power (LPₘₐₓ) voltage level 914 may be nominally defined at 1.2 Volts (V).

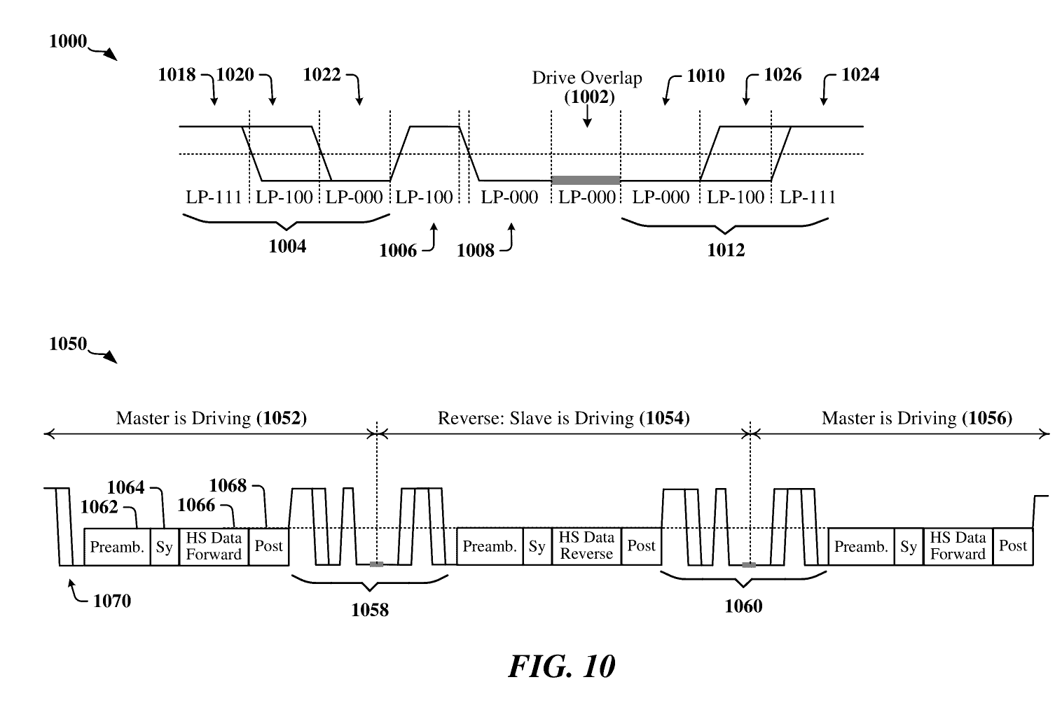

With reference to FIG. 10, transitions between modes of communication in a conventional C-PHY interface are effected using low-power mode signaling. In one example illustrated in the first timing diagram 1000, a transition from low-power mode to high-speed mode is indicated by transmission of the sequence of signaling states, which are implemented using the voltage levels defined for low-power modes of communication.

When a high-speed mode bus turnaround is desired, conventional C-PHY devices use low-power mode signaling. Turnaround is used to provide communication opportunities for slave devices at high-speed data rates when the C-PHY interface provides a bidirectional lane between a master device and a slave device. The transmission direction of a bidirectional lane can be changed using a procedure defined by conventional C-PHY protocols. The procedure toggles direction of data flow over the C-PHY link, such that the same procedure is executed to change data flow from a master to slave (forward direction) to data flow from the slave to the master (reverse direction) and to change data flow from the reverse direction to the forward direction.

The first timing diagram 1000 illustrates execution of a change of direction from forward direction to reverse direction. The procedure is initiated when the master device transmits a first Stop state 1018, a first Low-Power Request state 1020 and a Bridge state 1022. The master device then transmits a second Low-Power Request state 1006 followed by a second Bridge state 1022. The master device asserts the second Bridge state 1022 for a predefined minimum period of time before releasing the interface. The master device releases the interface when it ceases to drive the three wires of the interface. The slave device waits for a period of time after the commencement of the second Bridge state 1022 before driving the wires in a third Bridge state 1010. For some period of time, an overlap 1002 occurs when both the master device and slave device may be driving the wires of the interface. The slave device then drives a second Low-Power Request state 1026. The master device may identify the second Low-Power Request state 1026 as an acknowledgement that the slave device has taken control of the interface. The slave device drives a second Stop state 1024 to confirm completion of bus turnaround.

The second diagram 1050 illustrates a sequence of high-speed transmissions 1052, 1054, 1056 that involves two turnaround procedures 1058, 1060. The first transmission 1052 is a forward transmission from a master device to a slave device, the second transmission 1054 is a reverse transmission from the slave device to the master device, and the third transmission 1056 is a forward transmission from the master device to the slave device. In the first transmission 1052, for example, the transmitting device (here the master device) transmits a sequence 1070 of low-power states to cause the C-PHY interface to enter high-speed communication mode. The transmitting device then transmits a high-speed preamble 1062 and synchronization symbols 1064, which cause the receiving device to generate a receive clock and attain synchronization prior to transmission of the high-speed data 1066. A Post sequence 1068 is transmitted to indicate that end of the transmission. The transmitting device then exits high-speed mode to perform the turnaround procedure 1058 or 1060 that results in link turnaround and reentry to high-speed mode. Each of the turnaround procedures 1058 or 1060 includes transmission of the same sequence of low-power signaling states.

The use of low-power signaling to perform turnaround procedures can result in decreased performance of a C-PHY interface. Each of the signaling states used in the turnaround procedures is asserted for predefined minimum periods of times that permit the transitioning of signals within the low-power voltage ranges. The duration of the turnaround procedure can decrease the overall data rate of the C-PHY interface significantly.

Symbol-Based Mode Control in a C-PHY Interface

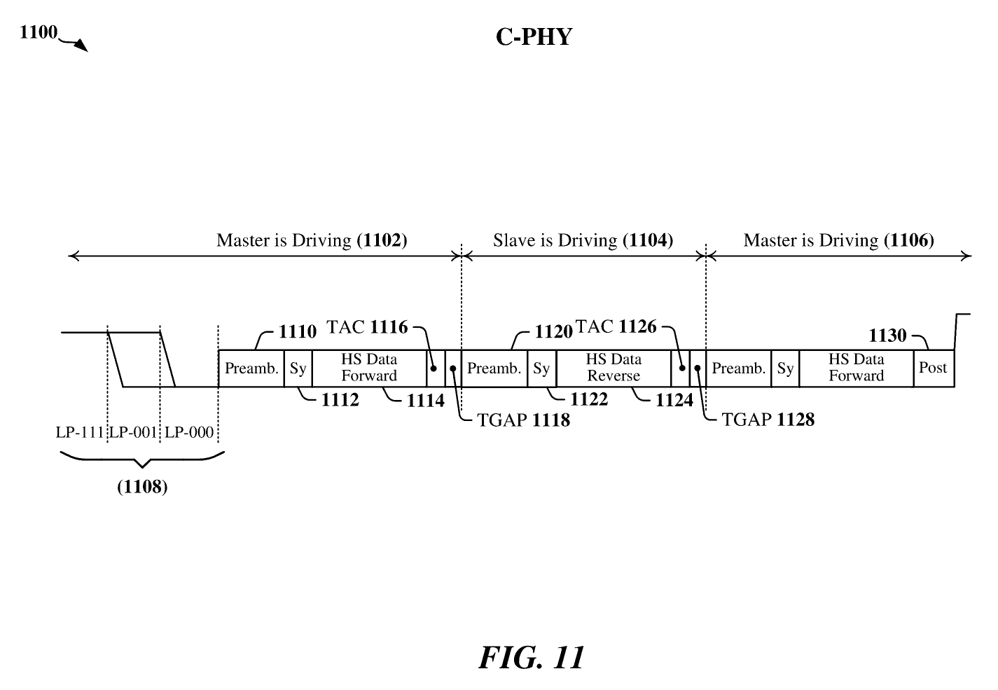

Certain aspects disclosed herein, relate to a turnaround procedure for C-PHY interfaces that can be performed without entering low-power mode of communication. In some instances, each turnaround time can be reduced by approximately 1 microsecond. FIG. 11 illustrates one example, in which turnaround may be accomplished in high-speed mode by transmitting unused (unmapped) symbol sequences in the high-speed data to signal a turn-around event. As disclosed herein, a C-PHY interface using three signal wires may transmit a 16-bit word in a sequence of seven 3-Phase symbols such that clock information is embedded by causing at least one of the three signal wires to experience a change in signaling state between each pair of consecutively transmitted symbols. As illustrated in FIG. 6, a transmitter 600 may use a mapper 604 to select a sequence of 7 symbols 614 in a protocol layer above the symbol encoding. The sequence of seven symbols is serialized and used by a symbol encoder 610 to determine a signaling state of a trio (the 3-wire link 612) based on the signaling state produced from the previous symbol. In each symbol time epoch, the signals on the three-wire trio can transition to one of five other states. In a group of seven consecutive symbols there are 5⁷=78,125 possible permutations, with only 2¹⁶=65,536 permutations needed to encode 16 bits of information, leaving 12,589 permutations of seven symbols that are not used by the mapper 604. Some of the permutations (seven-symbol sequences) may be assigned for special purposes such as the Sync Word 1112 and the Post sequence 1130, which the PHY is configured to detect during normal reception of high-speed data. The Preamble 1110 consists of a continuous steam of symbols having the same value that is transmitted prior to the first occurrence of the Sync Word 1112. The Preamble 1110 does not need to be assigned an unmapped permutation code, and the interpretation of the Preamble 1110 is based on burst reception state. Some of the unused seven-symbol sequences might be used for other purposes such as run-length control. Even with these other uses of unmapped seven-symbol sequences, there remain unused sequences available for other purposes.

According to certain aspects, an unused sequence may be assigned as Turnaround Code (TAC) 1116, 1126. The TAC 1116, 1126 is transmitted to signal the receiver to stop reception and to indicate that a change in the direction of transmission is to occur. As illustrated in the timing diagram 1100 of FIG. 11, a high-speed burst begins after transmission of a Start of Transmission (SoT) sequence 1108 that may include LP codes {LP-111, LP-001, LP-000} as described in relation to FIG. 10. In high-speed communication mode, transmission begins with a Preamble 1110 and a Sync Word 1112, followed by the High-Speed Forward Data 1114. At the end of the High-Speed Forward Data 1114 the master device sends a TAC 1116 to signal a change in direction. The master device then commences a turnaround gap (TGAP) 1118 by driving the physical interface to a fixed state, and then begins to disable its High-Speed drivers. In one example, the interface is in the +x state (see FIG. 4) during the TGAP 1118. The slave device begins driving the same +x state on the physical interface during TGAP 1118. After a delay, the slave device begins to transmit the Preamble 1120 followed by the Sync pattern 1122 to synchronize the receiver in the master device. After the slave device has transmitted the Sync pattern 1122, it may send High-Speed Reverse Data 1124 to the master device. At the end of the High-Speed Reverse Data 1124 the slave device sends a TAC 1126 to signal a change in direction. The slave device then commences a TGAP 1128 by driving the physical interface to a fixed state, and then begins to disable its High-Speed drivers. The change from reverse direction to forward direction is then completed when the master device drives the interface during the TGAP 1128.

The TAC 1116, 1126 provides a robust method of indicating change of direction and the TAC 1116, 1126 may operate, in certain respects, like the Post sequence 1130. Whereas the Post sequence 1130 is used to indicate the end of a high-speed transmission and a return to the low-power communication mode, the TAC 1116, 1126 provides a receiver with an indication of the end of high-speed transmission in one direction prior to the commencement of high-speed transmission in the opposite direction. The transmitting device may disable or otherwise modify the operation of its high-speed drivers after sending a TAC 1116, 1126 or a Post sequence 1130, while the receiving device may enable or otherwise modify the operation of its high-speed receivers after receiving a TAC 1116, 1126 or a Post sequence 1130. Both the Post sequence 1130 and the TAC 1116, 1126 can be repeatedly transmitted. Repeating the TAC 1116 or 1126 enables a receiving device to generate a sufficient number of clock pulses to empty its data pipeline.

In one example, a first device that is configured to operate as a transmitter may stop driving the three signal wires after transmitting the TAC 1116, and during the corresponding TGAP 1118 may reconfigure its PHY to operate as a receiver. A second device that is configured to operate as a receiver may reconfigure its PHY to operate as a transmitter after detecting the TAC 1116 and the TGAP 1118. The second device may then drive the Preamble 1120 and Sync pattern 1122 to synchronize the first and second devices.

In some implementations, the duration of the TAC 1116, 1126 is similar to the duration of the Post sequence 1130. The number of repetitions of the TAC 1116, 1126 may be configured within a predefined or preconfigured range. For example, a designer may configure transmitter to operate with between 0 and k repetitions of the TAC 1116, 1126 (or the Post sequence 1130) based on operating conditions, packet sizes transmitted and so on. The duration of the TGAP 1118, 1128 may be configured to provide sufficient time to prevent driver overlap. The duration allocated or configured for TGAP 1118, 1128 may be determined based on application-specific conditions, driver turnoff characteristics, device technology, voltage and/or current driver performance characteristics and other parameters. In some examples, a “Break before Make” approach is adopted, where the line drivers of the first device (initial transmitter) are expected to enter a high impedance state before the line drivers of the second device (new transmitter) exit high impedance state. Certain driver types may be operable with some overlap when line drivers of both devices are active.

Packet-Based Mode Control in C-PHY and D-PHY Interfaces

Certain aspects disclosed herein, relate to a turnaround procedure for C-PHY and D-PHY interfaces that can be performed by transmitting a turnaround packet, sub-packet or sequence that enables turnaround without entering low-power mode of communication. In some instances, each turnaround time can be reduced by approximately 1 microsecond.

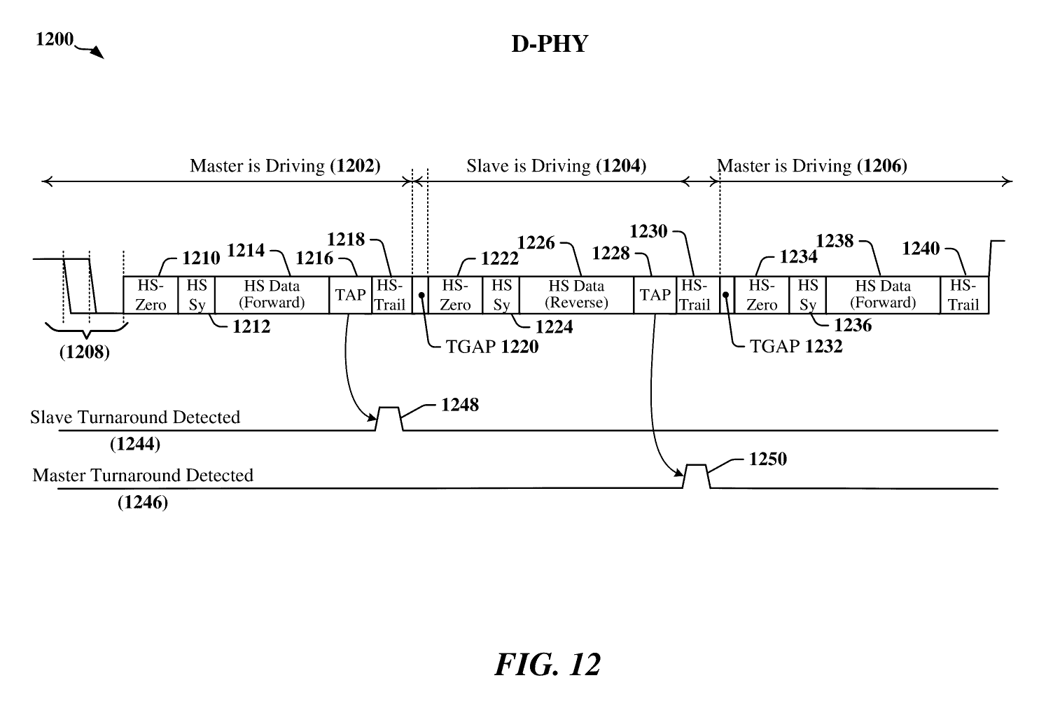

FIG. 12 illustrates an example related to a D-PHY interface. A turnaround packet (TAP) 1216, 1228 may be transmitted in high-speed mode to signal a turn-around event. According to certain aspects, the TAP 1216, 1228 may be transmitted to signal the receiver to stop reception and to change the direction of transmission. As illustrated in the timing diagram 1200 of FIG. 12, a high-speed burst begins after transmission of a Start of Transmission (SoT) sequence 1208 that may include LP codes {LP-11, LP-01, LP-00}. In high-speed communication mode, transmission begins with a high-speed zero (HS-Zero) 1210 and a high-speed Sync Word (HS Sy) 1212, followed by the High-Speed Forward Data 1214. At the end of the High-Speed Forward Data 1214 the master device sends a TAP 1216 to signal a change in direction. The master device then transmits a high-speed Trail (HS-Trail) 1218 before commencing a turnaround gap (TGAP) 1220 by driving the physical interface to a fixed state, for example. In the TGAP 1220, the master device begins to disable its High-Speed drivers. The slave device, having detected the TAP 1216 and generated a pulse 1248 on a control signal 1244, begins driving the TGAP 1220 on the physical interface. After a delay, the slave device begins to transmit the HS-Zero 1222 followed by the Sync word 1224 to synchronize the receiver in the master device. After the slave device has transmitted the Sync word 1224, it may send High-Speed Reverse Data 1226 to the master device. At the end of the High-Speed Reverse Data 1226 the slave device sends a TAP 1228 to signal a change in direction. The slave device then transmits a high-speed Trail (HS-Trail) 1230 before commencing a TGAP 1232. In the TGAP 1232, the slave device begins to disable its High-Speed drivers. The master device detects the TAP 1228 and may generate a pulse 1250 on a control signal 1246. The change from reverse direction to forward direction is then completed when the master device drives the interface during the TGAP 1232.

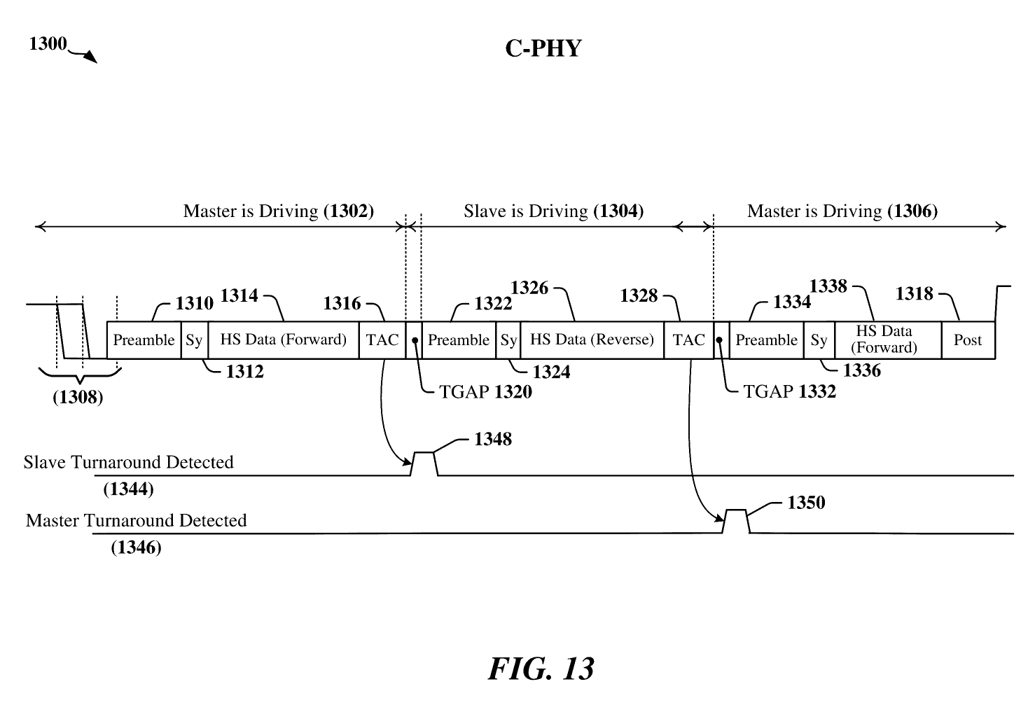

FIG. 13 illustrates an example related to a C-PHY interface. A TAC 1316, 1328 may be transmitted in high-speed mode to signal a turn-around event. According to certain aspects, the TAC 1316, 1328 may be transmitted to signal the receiver to stop reception and to change the direction of transmission. As illustrated in the timing diagram 1300 of FIG. 13, a high-speed burst begins after transmission of a SoT sequence 1308 that may include LP codes {LP-111, LP-001, LP-000}. In high-speed communication mode, transmission begins with a Preamble 1310 and a Sync pattern 1312, followed by the High-Speed Forward Data 1314 (as discussed, for example, in relation to FIG. 11). At the end of the High-Speed Forward Data 1314 the master device sends a TAC 1316 to signal a change in direction, before commencing a turnaround gap (TGAP) 1320 by driving the physical interface to a fixed state, for example. In the TGAP 1320, the master device begins to disable its High-Speed drivers. The slave device, having detected the TAC 1316 and generated a pulse 1348 on a control signal 1344, begins driving the TGAP 1320 on the physical interface. After a delay, the slave device begins to transmit the Preamble 1322 followed by the Sync pattern 1324 to synchronize the receiver in the master device. After the slave device has transmitted the Sync pattern 1324, it may send High-Speed Reverse Data 1326 to the master device. At the end of the High-Speed Reverse Data 1326 the slave device sends a TAC 1328 to signal a change in direction before commencing a TGAP 1332. In the TGAP 1332, the slave device begins to disable its High-Speed drivers. The master device detects the TAC 1328 and may generate a pulse 1350 on a control signal 1346. The change from reverse direction to forward direction is then completed when the master device drives the interface during the TGAP 1332.

In the TGAP 1220, 1232, 1320, 1332, a first device that is initially configured to operate as a transmitter may stop driving the signal wires of the interface after transmitting the TAP 1216, 1228 or TAC 1316, 1328, and during the corresponding TGAP 1220, 1232, 1320, 1332, may reconfigure its PHY to operate as a receiver. A second device that is initially configured to operate as a receiver may reconfigure its PHY to operate as a transmitter after detecting the TAP 1216, 1228 or TAC 1316, 1328 and the subsequent TGAP 1220, 1232, 1320, 1332.

The duration of the TGAP 1220, 1232, 1320, 1332 may be configured to provide sufficient time to prevent driver overlap. The duration allocated or configured for TGAP 1220, 1232, 1320, 1332 may be determined based on application-specific conditions, driver turnoff characteristics, device technology, voltage and/or current driver performance characteristics and other parameters. In some examples, a “Break before Make” approach is adopted, where the line drivers of the first device (initial transmitter) are expected to enter a high impedance state before the line drivers of the second device (new transmitter) exit high impedance state. Certain driver types may be operable with some overlap when line drivers of both devices are active. When high-speed mode is to be terminated, the master device may transmit a Post sequence 1318.

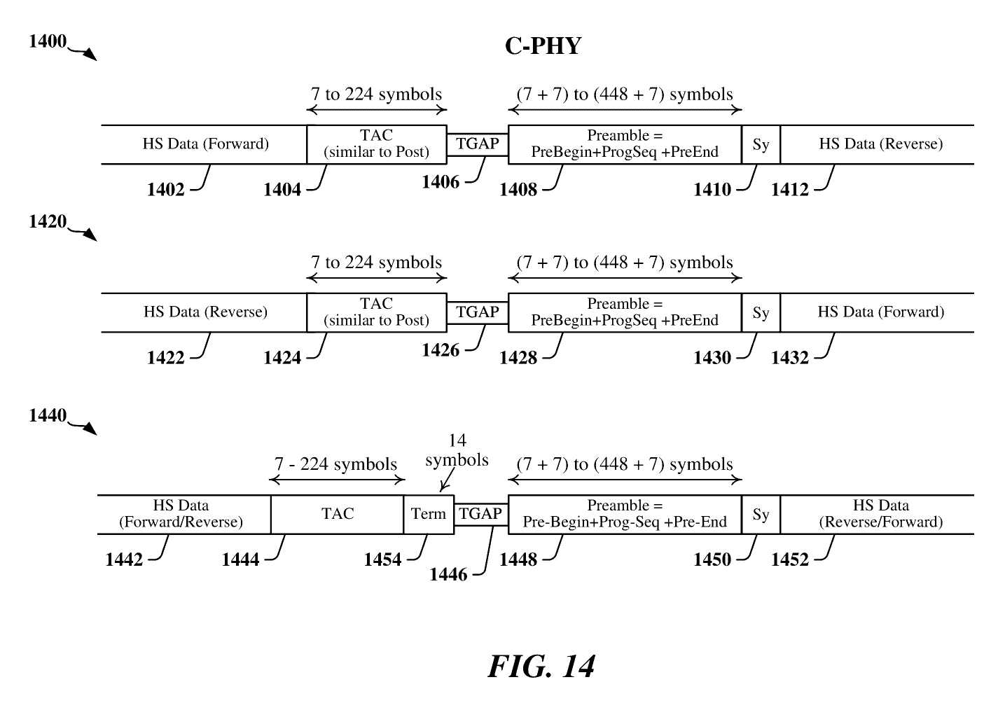

FIG. 14 illustrates certain aspects related to the use of the TAC in a C-PHY interface. A first timing diagram 1400 illustrates certain aspects related to the turnaround illustrated in FIG. 13 from forward mode transmission by the master to reverse mode transmission by a slave. After transmitting forward data 1402, a TAC 1404 is transmitted. The length of the TAC 1404 typically has a length that is similar to the length of a Post sequence 1318 that may otherwise be transmitted. In addition to the function performed by the Post sequence 1318, the TAC 1404 indicates that a turnaround event is to occur. The length of the TAC 1404 may be variable. The TAC 1404 may have a repetition length that is programmable within a range (as with the Post sequence 1318).

After transmitting the TAC 1404, the link enters a TGAP period 1406, which may be provided to avoid driver overlap. In one example, the TGAP period 1406 may extend for approximately 14 symbols (2 data words). The change of active driver operates in a break-before-make mode, where the active driver in the master enters high impedance mode before the driver in the slave enters active mode. Drivers and receivers change directions during the TGAP period 1406.

The slave then transmits the Preamble 1408 and Sync 1410. The Preamble 1408 may include a Pre-Begin that can range between 7 and 448 symbols, a Programmable sequence (optional), and a Pre-End that is 7 symbols in length. The slave may then transmit high speed data 1412.

A second timing diagram 1420 illustrates certain aspects related to the turnaround illustrated in FIG. 13 from reverse mode transmission by the slave to forward mode transmission by the master. After transmitting reverse data 1422, a TAC 1424 is transmitted. The length of the TAC 1424 typically has a length that is similar to the length of a Post sequence 1318 that may otherwise be transmitted. In addition to the function performed by the Post sequence 1318, the TAC 1424 indicates that a turnaround event is to occur. The length of the TAC 1424 may be variable. The TAC 1424 may have a repetition length that is programmable within a range.

After transmitting the TAC 1424, the link enters a TGAP period 1426, which may be provided to avoid driver overlap. In one example, the TGAP period 1426 may extend for approximately 14 symbols (2 data words). The change of active driver operates in a break-before-make mode, where the active driver in the slave enters high impedance mode before the driver in the master enters active mode. Drivers and receivers change directions during the TGAP period 1426.

The master then transmits the Preamble 1428 and Sync 1430. The Preamble 1428 may include a Pre-Begin that can range between 7 and 448 symbols, a Programmable sequence (optional), and a Pre-End that is 7 symbols in length. The master may then transmit high speed data 1432.

As noted in the first timing diagram 1400 and the second timing diagram 1420, the duration of the TAC 1404, 1424 can vary. A receiving device may be unable to determine precisely when the TGAP period 1406, 1426 begins, which can result in unexpected driver overlap in some implementations. According to certain aspects, the active driver may explicitly indicate that the TAC 1404, 1424 has ended. The timing diagram 1440 illustrates one example in which a termination code (Term 1454) is transmitted after the TAC 1444. After transmitting high-speed data 1442, the TAC 1444 is transmitted. The TAC 1444 indicates that a turnaround event is to occur. The length of the TAC 1444 may vary between implementations or applications and may have a repetition length that is programmable.

The Term 1454 follows the TAC 1444 in transmission. The Term 1454 may have a length of 14 symbols (2 data words). In one example, each symbol in the Term 1454 is a 3. After transmitting the Term 1454, the link enters the TGAP period 1446, which may be provided to avoid driver overlap. The TGAP period 1406 may extend for approximately 14 symbols (2 data words).

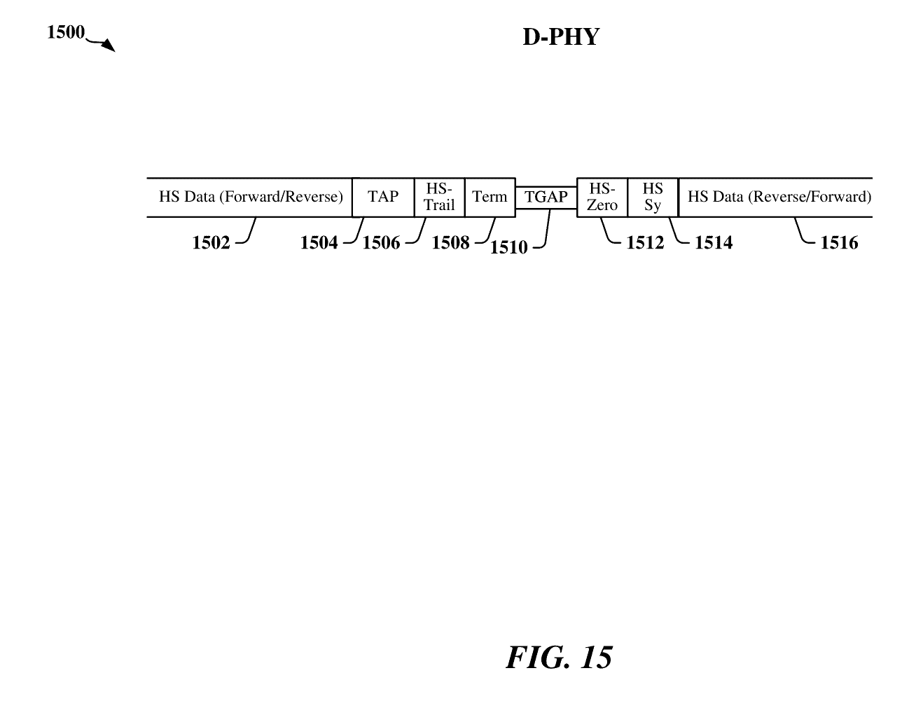

FIG. 15 illustrates an example in which a Term packet, signaling event or other indication of the beginning of a TGAP period 1510 in a D-PHY interface adapted to indicate line turnaround while operating in a high-speed mode of communication. An initially active device may indicate line turnaround by transmitting a data packet or an embedded signal that is not recognized as a data packet. In one example, an embedded signal may be configured such that the PHY in the receiving device can determine that line-turnaround is imminent without decoding the high-speed data. Upon receiving an indication of line-turnaround, a receiving device may expect the arrival of a high-speed Trail (HS-Trail 1506) and Term 1508 transmissions.

In the illustrated example, the initially active device sends a TAP 1504 to signal a change in direction at the end of the High-Speed Forward Data 1502 transmission. The initially active device then transmits the HS-Trail 1506. The Term 1508 is then transmitted before commencing the TGAP period 1510. In the TGAP period 1510, the initially active device begins to disable its High-Speed drivers. The initially inactive device, having detected the TAP 1504 and the Term 1508 may transmit the HS-Zero 1512 followed by the Sync word 1514 and High-Speed Data 1516.

As noted in the first timing diagram 1400 and the second timing diagram 1420, the duration of the TAC 1404, 1424 can vary. A receiving device may be unable to determine precisely when the TGAP period 1406, 1426 begins, which can result in unexpected driver overlap in some implementations. According to certain aspects, the active driver may explicitly indicate that the TAC 1404, 1424 has ended. The timing diagram 1440 illustrates one example in which a termination code (Term 1454) is transmitted after the TAC 1444. After transmitting high-speed data 1442, the TAC 1444 is transmitted. The TAC 1444 indicates that a turnaround event is to occur. The length of the TAC 1444 may vary between implementations or applications and may have a repetition length that is programmable.

The Term 1454 follows the TAC 1444 in transmission. The Term 1454 may have a length of 14 symbols (2 data words). In one example, each symbol in the Term 1454 is a 3. After transmitting the Term 1454, the link enters the TGAP period 1446, which may be provided to avoid driver overlap. The TGAP period 1406 may extend for approximately 14 symbols (2 data words).

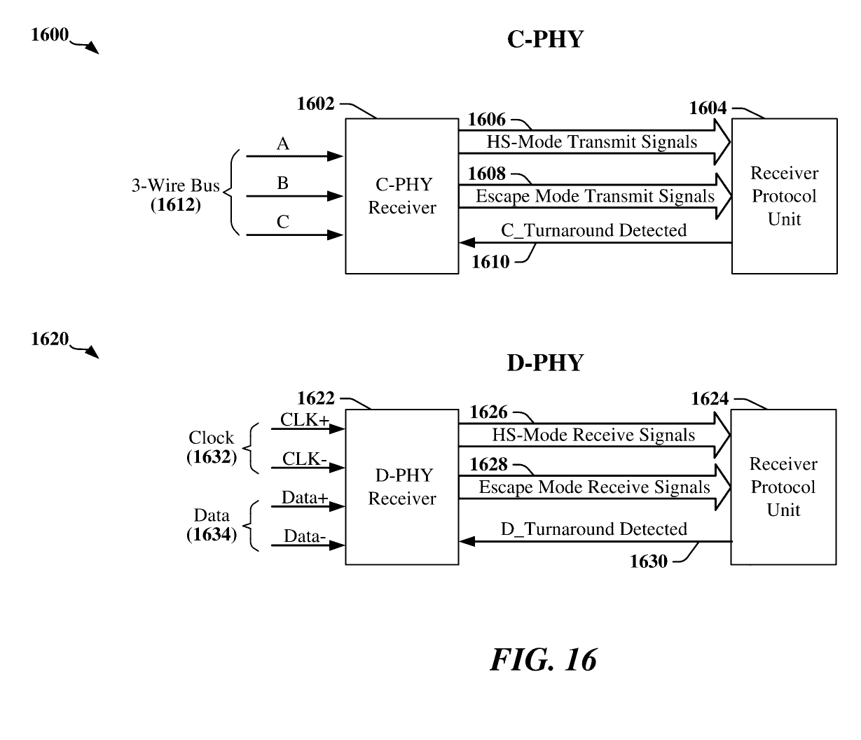

FIG. 16 illustrates a configuration of a C-PHY device 1600 showing signals provided between a C-PHY receiver 1602 and a Protocol Unit 1604, and a configuration of a D-PHY device 1620 showing signals provided between a D-PHY receiver 1622 and a Protocol Unit 1624. The C-PHY receiver 1602 receives data from a 3-wire bus 1612 and provides received high-speed mode signals 1606 and Escape mode signals 1608 to the Protocol Unit 1604. The Protocol Unit 1604 detects the TAC 1316, 1328 (FIG. 13) and provides a control signal (C_Turnaround_Detected 1610) to the C-PHY receiver 1602 indicating that a change of direction of transmission is requested. The D-PHY receiver 1622 receives a clock signal from the clock lane 1632 and data from one or more data lanes 1634 and provides received high-speed mode signals 1626 and Escape mode signals 1628 to the Protocol Unit 1624. The Protocol Unit 1624 detects the TAP 1216, 1228 (FIG. 12) and provides a control signal (D_Turnaround_Detected 1630) to the D-PHY receiver 1622 indicating that a change of direction of transmission is requested.

Additional Descriptions of Certain Aspects

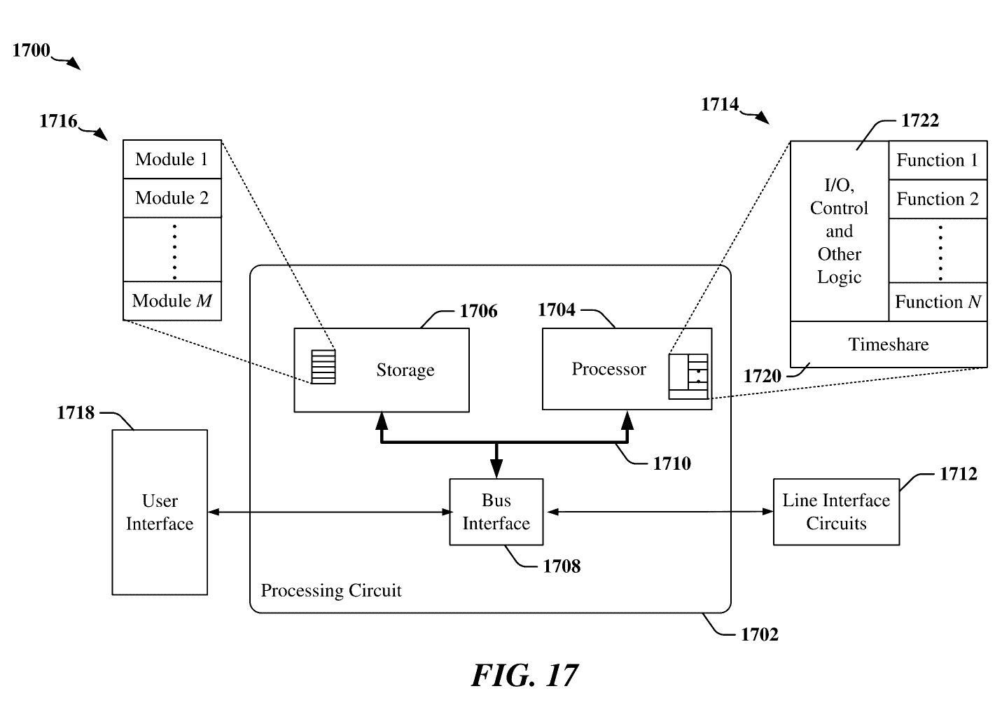

FIG. 17 is a conceptual diagram 1700 illustrating a simplified example of a hardware implementation for an apparatus employing a processing circuit 1702 that may be configured to perform one or more functions disclosed herein. In accordance with various aspects of the disclosure, an element, or any portion of an element, or any combination of elements as disclosed herein may be implemented using the processing circuit 1702. The processing circuit 1702 may include one or more processors 1704 that are controlled by some combination of hardware and software modules. Examples of processors 1704 include microprocessors, microcontrollers, digital signal processors (DSPs), ASICs field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices, and may be referred to herein as computer-readable media and/or processor-readable media. The bus 1710 may also link various other circuits such as timing sources, timers, peripherals, voltage regulators, and power management circuits. A bus interface 1708 may provide an interface between the bus 1710 and one or more line interface circuits 1712. A line interface circuit 1712 may be provided for each networking technology supported by the processing circuit. In some instances, multiple networking technologies may share some or all of the circuitry or processing modules found in a line interface circuit 1712. Each line interface circuit 1712 provides a means for communicating with various other apparatus over a transmission medium. Depending upon the nature of the apparatus, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain software maintained and/or organized in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704, and may manage access to external devices such as the line interface circuit 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to the line interface circuit 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the line interface circuit 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

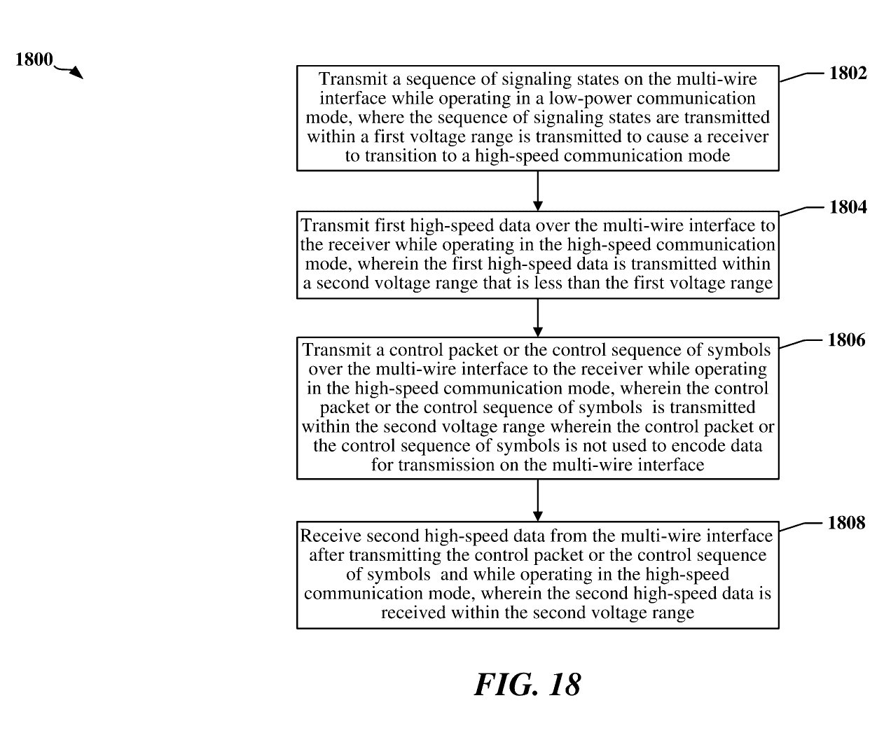

FIG. 18 is a flow chart 1800 of a method operational a device coupled to a multi-wire interface.

At block 1802, the device may transmit a sequence of signaling states on the multi-wire interface while operating in a low-power communication mode. The sequence of signaling states may be transmitted within a first voltage range. The sequence of signaling states may be transmitted to cause a receiver to transition to a high-speed communication mode.

At block 1804, the device may transmit first high-speed data over the multi-wire interface to the receiver while operating in the high-speed communication mode. The first high-speed data may be transmitted within a second voltage range that is less than the first voltage range.

At block 1806, the device may transmit a control packet or a control sequence of symbols over the multi-wire interface to the receiver while operating in the high-speed communication mode. The control packet or the control sequence of symbols may be transmitted within the second voltage range and may include a sequence of symbols that is not used to encode data for transmission on the multi-wire interface.

At block 1808, the device may receive second high-speed data from the multi-wire interface after transmitting the control packet or the control sequence of symbols and while operating in the high-speed communication mode. The second high-speed data may be received within the second voltage range.

In one example, the multi-wire interface is a C-PHY interface defined by MIPI Alliance specifications. The first voltage range may span approximately 1.2 Volts and the second voltage range may span less than 300 millivolts.

In some instances, the device may drive the multi-wire interface to a predefined state defined within the second voltage range after transmitting the control sequence of symbols. The device may disable one or more line drivers after transmitting the control sequence of symbols. The device may signal the commencement of a gap period (e.g., TGAP period 1446, 1510) during which the one or more line drivers will be disabled. In one example, the signaling in advance of the gap period may be implemented using a termination packet or a sequence of symbols transmitted on the multi-wire interface. In another example, the signaling in advance of the gap period may be implemented by causing signaling perturbations, exceptions, unique states, or the like on the multi-wire interface.

In some examples, the control sequence of symbols is transmitted. The control sequence of symbols is selected from a total of 78,125 sequences of symbols available to a mapper that maps 16 bits of data to sequences of 7 symbols. Each 16-bit word of the first high-speed data may be mapped to one of 65,536 sequences of 7 symbols. A total of 78,125 unique sequences of 7 symbols may be available for mapping 16-bit words. The control sequence of symbols may be one of 12,589 sequences of 7 symbols that are not used for mapping 16-bit words.

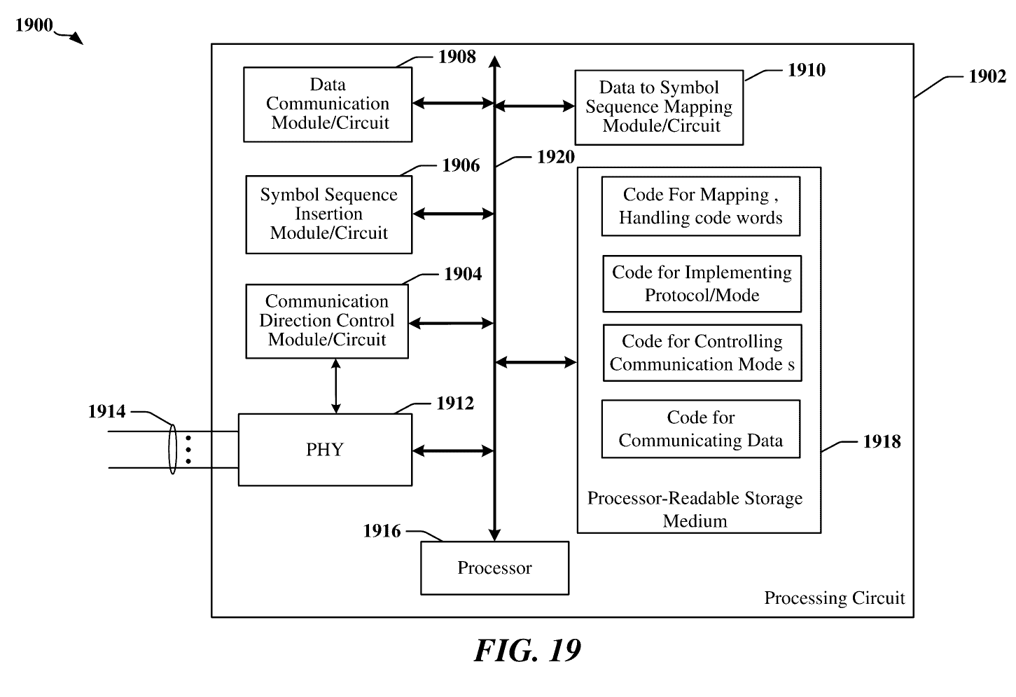

FIG. 19 is a diagram illustrating a simplified example of a hardware implementation for an apparatus 1900 employing a processing circuit 1902. The processing circuit typically has a processor 1916 that may include one or more of a microprocessor, microcontroller, digital signal processor, a sequencer and a state machine. The processing circuit 1902 may be implemented with a bus architecture, represented generally by the bus 1920. The bus 1920 may include any number of interconnecting buses and bridges depending on the specific application of the processing circuit 1902 and the overall design constraints. The bus 1920 links together various circuits including one or more processors and/or hardware modules, represented by the processor 1916, the modules or circuits 1904, 1906, 1908, and 1908, a PHY 1912 configurable to communicate over connectors or wires of a multi-wire communication link 1914 and the computer-readable storage medium 1918. The bus 1920 may also link various other circuits such as timing sources, peripherals, voltage regulators, and power management circuits.

The processor 1916 is responsible for general processing, including the execution of software stored on the computer-readable storage medium 1918. The software, when executed by the processor 1916, causes the processing circuit 1902 to perform the various functions described supra for any particular apparatus. The computer-readable storage medium 1918 may also be used for storing data that is manipulated by the processor 1916 when executing software, including data decoded from symbols transmitted over the communication link 1914, which may be configured as data lanes and clock lanes. The processing circuit 1902 further includes at least one of the modules 1904, 1906, 1908, and 1908. The modules 1904, 1906, 1908, and 1908 may be software modules running in the processor 1916, resident/stored in the computer-readable storage medium 1918, one or more hardware modules coupled to the processor 1916, or some combination thereof. The 1904, 1906, 1908, and/or 1908 may include microcontroller instructions, state machine configuration parameters, or some combination thereof.

In one configuration, the apparatus 1900 for data communication includes modules and/or circuits 1908, 1912 configured to transmit and receive data in sequences of symbols using a multi-wire communication link 1914. The apparatus may include modules and/or circuits 1904 configured to reconfigure the direction of the PHY 1912, including when operated in a high-speed mode of operation. The apparatus may include modules and/or circuits 1906, 1910 configured to insert and/or substitute control sequences of symbols into the stream of symbols transmitted on the multi-wire communication link 1914.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed in a device coupled to a multi-wire interface, comprising:
transmitting a sequence of signaling states on the multi-wire interface while operating in a low-power communication mode, where the sequence of signaling states is transmitted within a first voltage range, and the sequence of signaling states is transmitted to cause a receiver to transition to a high-speed communication mode;
transmitting first high-speed data over the multi-wire interface to the receiver while operating in the high-speed communication mode, wherein the first high-speed data is transmitted within a second voltage range that is less than the first voltage range;
transmitting a control packet or control sequence of symbols over the multi-wire interface to the receiver while operating in the high-speed communication mode, wherein the control packet or the control sequence of symbols is transmitted within the second voltage range that comprises a sequence of symbols, wherein the control packet or the control sequence of symbols is not used to encode data for transmission on the multi-wire interface; and
receiving second high-speed data from the multi-wire interface after transmitting the control packet or the control sequence of symbols and while operating in the high-speed communication mode, wherein the second high-speed data is received within the second voltage range.

2. The method of claim 1, wherein the multi-wire interface is a C-PHY interface defined by Mobile Industry Processor Interface (MIPI) Alliance specifications, and wherein the first voltage range spans approximately 1.2 Volts and the second voltage range spans less than 600 millivolts.

3. The method of claim 1, wherein the multi-wire interface is a D-PHY interface defined by Mobile Industry Processor Interface (MIPI) Alliance specifications, and wherein the first voltage range spans approximately 1.2 Volts and the second voltage range spans less than 600 millivolts.

4. The method of claim 1, further comprising:
driving the multi-wire interface to a predefined state defined within the second voltage range after transmitting the control packet or the control sequence of symbols.

5. The method of claim 1, further comprising:
disabling one or more line drivers after transmitting the control packet or the control sequence of symbols.

6. The method of claim 5, further comprising:
signaling commencement of a gap period during which the one or more line drivers are to be disabled by transmitting a termination packet, a sequence of symbols or a signal perturbation on the multi-wire interface.

7. The method of claim 1, further comprising:
mapping each 16-bit word of the first high-speed data to one of 65,536 sequences of 7 symbols,
wherein a total of 78,125 unique sequences of 7 symbols are available for mapping 16-bit words.

8. The method of claim 7, wherein the control sequence of symbols is transmitted and is one of 12,589 sequences of 7 symbols that are not used for mapping 16-bit words.

9. An apparatus comprising:
a physical interface coupled to a 3-wire link;
a mapper adapted to convert data to sequences of 3-phase symbols to be transmitted on the 3-wire link; and
a processor configured to:
transmit a sequence of signaling states on the 3-wire link while operating in a low-power communication mode, where the sequence of signaling states are transmitted within a first voltage range is transmitted to cause a receiver to transition to a high-speed communication mode;
transmit first high-speed data over the 3-wire link to the receiver while operating in the high-speed communication mode, wherein the first high-speed data is transmitted within a second voltage range that is less than the first voltage range;
transmit a control packet or control sequence of symbols over the 3-wire link to the receiver while operating in the high-speed communication mode, wherein the control packet or the control sequence of symbols is transmitted within the second voltage range that comprises a sequence of symbols, wherein the control packet or the control sequence of symbols is not used to encode data for transmission on the 3-wire link; and
receive second high-speed data from the 3-wire link after transmitting the control sequence of symbols and while operating in the high-speed communication mode, wherein the second high-speed data is received within the second voltage range.

10. The apparatus of claim 9, wherein the 3-wire link is operated in accordance with specifications defined by Mobile Industry Processor Interface (MIPI) Alliance for a C-PHY interface.

11. The apparatus of claim 9, wherein the first voltage range spans approximately 1.2 Volts and the second voltage range spans less than 300 millivolts.

12. The apparatus of claim 9, wherein the processor is configured to:
drive the 3-wire link to a predefined state defined within the second voltage range after transmitting the control packet or the control sequence of symbols.

13. The apparatus of claim 9, wherein the processor is configured to:
disable one or more line drivers after transmitting the control packet or the control sequence of symbols.

14. The apparatus of claim 13, wherein the processor is configured to:
signal the commencement of a gap period during which the one or more line drivers are to be disabled by transmitting a termination packet, a sequence of symbols or a signal perturbation on the 3-wire link.

15. The apparatus of claim 9, wherein the processor is configured to:
map each 16-bit word of the first high-speed data to one of 65,536 sequences of 7 symbols,
wherein a total of 78,125 unique sequences of 7 symbols are available for mapping 16-bit words.

16. The apparatus of claim 15, wherein the control sequence of symbols is transmitted and is one of 12,589 sequences of 7 symbols that are not used for mapping 16-bit words.

17. A processor readable storage medium comprising code for:
transmitting a sequence of signaling states on a multi-wire interface while operating in a low-power communication mode, where the sequence of signaling states are transmitted within a first voltage range is transmitted to cause a receiver to transition to a high-speed communication mode;
transmitting first high-speed data over the multi-wire interface to the receiver while operating in the high-speed communication mode, wherein the first high-speed data is transmitted within a second voltage range that is less than the first voltage range;
transmitting a control packet or control sequence of symbols over the multi-wire interface to the receiver while operating in the high-speed communication mode, wherein the control packet or the control sequence of symbols is transmitted within the second voltage range that comprises a sequence of symbols, wherein the control packet or the control sequence of symbols is not used to encode data for transmission on the multi-wire interface; and
receiving second high-speed data from the multi-wire interface after transmitting the control sequence of symbols and while operating in the high-speed communication mode, wherein the second high-speed data is received within the second voltage range.

18. The storage medium of claim 17, wherein the multi-wire interface is a C-PHY interface defined by Mobile Industry Processor Interface (MIPI) Alliance specifications.

19. The storage medium of claim 17, wherein the first voltage range spans approximately 1.2 Volts and the second voltage range spans less than 300 millivolts.

20. The storage medium of claim 17, further comprising code for:
driving the multi-wire interface to a predefined state defined within the second voltage range after transmitting the control packet or the control sequence of symbols.

21. The storage medium of claim 17, further comprising code for:
disabling one or more line drivers after transmitting the control packet or the control sequence of symbols.

22. The storage medium of claim 21, further comprising code for:
signaling commencement of a gap period during which the one or more line drivers are to be disabled, including code for transmitting a termination packet, a sequence of symbols or a signal perturbation on the multi-wire interface.

23. The storage medium of claim 17, further comprising code for:
mapping each 16-bit word of the first high-speed data to one of 65,536 sequences of 7 symbols,
wherein a total of 78,125 unique sequences of 7 symbols are available for mapping 16-bit words,
wherein the control sequence of symbols is transmitted and is one of 12,589 sequences of 7 symbols that are not used for mapping 16-bit words.

24. An apparatus, comprising:
means for transmitting a sequence of signaling states on a multi-wire interface while operating in a low-power communication mode, where the sequence of signaling states are transmitted within a first voltage range is transmitted to cause a receiver to transition to a high-speed communication mode;
means for transmitting first high-speed data over the multi-wire interface to the receiver while operating in the high-speed communication mode, wherein the first high-speed data is transmitted within a second voltage range that is less than the first voltage range;
means for providing a control packet or control sequence of symbols to be transmitted over the multi-wire interface to the receiver while operating in the high-speed communication mode, wherein the control packet or the control sequence of symbols is transmitted within the second voltage range that comprises a sequence of symbols, wherein the control packet or the control sequence of symbols is not used to encode data for transmission on the multi-wire interface; and
means for receiving second high-speed data from the multi-wire interface after transmitting the control sequence of symbols and while operating in the high-speed communication mode, wherein the second high-speed data is received within the second voltage range.

25. The apparatus of claim 24, wherein the multi-wire interface is a C-PHY interface defined by Mobile Industry Processor Interface (MIPI) Alliance specifications.

26. The apparatus of claim 24, wherein the first voltage range spans approximately 1.2 Volts and the second voltage range spans less than 300 millivolts.

27. The apparatus of claim 24, further comprising:
means for driving the multi-wire interface to a predefined state defined within the second voltage range after transmitting the control packet or the control sequence of symbols.

28. The apparatus of claim 24, further comprising:
means for disabling one or more line drivers after transmitting the control packet or the control sequence of symbols,
wherein the means for transmitting first high-speed data over the multi-wire interface is configured to signal commencement of a gap period during which the one or more line drivers are to be disabled by transmitting a termination packet, a sequence of symbols or a signal perturbation on the multi-wire interface.

29. The apparatus of claim 24, wherein the control sequence of symbols is selected from a total of 78,125 sequences of symbols available to a mapper that maps 16 bits of data to sequences of 7 symbols.

30. The apparatus of claim 24, further comprising:
mapping each 16-bit word of the first high-speed data to one of 65,536 sequences of 7 symbols,
wherein a total of 78,125 unique sequences of 7 symbols are available for mapping 16-bit words,
wherein the control sequence of symbols is transmitted and is one of 12,589 sequences of 7 symbols that are not used for mapping 16-bit words.
